(19) United States
(12) Patent Application Publication
(10) Pub. No.: US 2020/0250185 A1
(43) Pub. Date: Aug. 6, 2020

(54) System and method for deriving merchant and product demographics from a transaction database

(71) Applicants: Russell Wayne Anderson, Avondale, PA (US); Pavel Bogdanov Nedanov, Newark, DE (US); Shantanu Chandra, West Bengal (IN)

(72) Inventors: Russell Wayne Anderson, Avondale, PA (US); Pavel Bogdanov Nedanov, Newark, DE (US); Shantanu Chandra, West Bengal (IN)

(21) Appl. No.: 10/638,648

(22) Filed: Aug. 12, 2003

(51) Int. Cl. G06F 16/2458; G06F 16/2457; G06F 16/23; G06Q 30/02; G06Q 30/00; G06F 9/46

(52) U.S. Cl. CPC G06F 16/2465; G06F 16/24573; G06F 16/24575; G06F 9/466; G06F 16/2358; G06Q 30/0254; G06Q 30/01; G06F 16/2308

(57) ABSTRACT

A method and system is disclosed for storing and manipulating customer transaction data received from a plurality of sources. The method may use a computer system comprising a storage device for storing the customer transaction data and a processor for processing the customer transaction data. The method may comprise receiving the customer transaction data, the customer transaction data relating to spending characteristics; appending customer demographic information to the customer transaction data, the customer demographic information including customer demographic variables; organizing the customer transaction data within a predetermined organizational structure; aggregating the customer transaction data based on at least one of customer demographic variables and spending characteristics; and creating a customer profile based on the customer transaction data.

This application is related to U.S. application Ser. No. ______ (Attorney Docket No. 47004.000209), also filed Aug. 12, 2003, which is incorporated herein by reference in its entirety.

### BACKGROUND OF THE INVENTION

The invention is directed to systems and methods for aggregating and utilizing transaction records at the customer level.

Every business wishes to know and understand more about the business environment in which they operate. Knowledge is required across a broad spectrum including knowledge about existing customers, knowledge about potential new customers and knowledge about a business' competitors, for example

The information to fuel this knowledge may be obtained from a variety of sources, as can be appreciated. For example, information about existing or potential customers may be obtained from surveys and polls, self-reported attributes and interests, questionnaires on warranty registrations, public records such as home sales and vehicle registrations and/or census bureau data, for example.

However, known techniques are deficient in that they fail to effectively utilize transaction information at the customer level. The systems and methods of the invention address this deficiency present in known techniques, as well as other problems.

### BRIEF SUMMARY OF THE INVENTION

A method and system is disclosed for storing and manipulating customer transaction data received from a plurality of sources. The method may use a computer system comprising a storage device for storing the customer transaction data and a processor for processing the customer transaction data. The method may comprise receiving the customer transaction data, the customer transaction data relating to spending characteristics; appending customer demographic information to the customer transaction data, the customer demographic information including customer demographic variables; organizing the customer transaction data within a predetermined organizational structure; aggregating the customer transaction data based on at least one of customer demographic variables and spending characteristics; and creating a customer profile based on the customer transaction data.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a flowchart showing processing in accordance with one embodiment of the invention;

FIG. 2 is a flowchart showing transaction based processing in accordance with one embodiment of the invention;

FIG. 3 is a flowchart showing the “obtain supplemental information” step of FIG. 2 in further detail in accordance with one embodiment of the invention;

FIG. 4 is a flowchart showing the “generate marketing information” step of FIG. 2 in further detail in accordance with one embodiment of the invention;

FIG. 5 is a flowchart showing the “define a first population in the portfolio” step of FIG. 4 in further detail in accordance with one embodiment of the invention;

FIG. 6 is a flowchart showing the “identify persons in the second population (to target) using the distinguishing preferences” step of FIG. 4 in further detail in accordance with one embodiment of the invention;

FIG. 7 is a flowchart showing the “identify persons in the second population based on rank ordered accounts” step of FIG. 6 in accordance with one embodiment of the invention;

FIG. 8 is a flowchart showing the “generate marketing information” step of FIG. 2 in accordance with a yet further embodiment of the invention;

FIG. 9 is a flowchart showing the “generate marketing information” step of FIG. 2 in accordance with a yet further embodiment of the invention;

FIG. 10 is a flowchart showing the “create customer preference information” step of FIG. 2 in further detail in accordance with one embodiment of the invention;

FIG. 11 is a flowchart showing the “identify transaction data that is associated with the particular class and/or merchant” step of FIG. 10 in further detail in accordance with one embodiment of the invention;

FIG. 12 is a flowchart showing the “identify all the merchants that are associated with a particular class of merchandise” step of FIG. 11 in further detail in accordance with one embodiment of the invention;

FIG. 13 is a flowchart showing the “generate marketing information” step of FIG. 2 in accordance with a yet further embodiment of the invention;

FIG. 14 is a flowchart showing the “organize the input merchant level customer purchase information” step of FIG. 2 in further detail in accordance with one embodiment of the invention;

FIG. 15 is a flowchart showing the “generate marketing information” step of FIG. 2 in accordance with a yet further embodiment of the invention;

FIG. 16 is a flowchart showing the “analyze the first account type to determine the use of a second account type held by the customer (the second account type being maintained by a different entity) step of FIG. 15 in further detail in accordance with one embodiment of the invention;

FIG. 17 is a flowchart showing the “generate marketing information” relating to customer and merchant profiling step of FIG. 2 in accordance with a yet further embodiment of the invention;

FIG. 18 is a flowchart showing the “apply the vector average value of the merchant against vector values representing potential customers” step of FIG. 17 in accordance with one embodiment of the invention;

FIG. 19 is a diagram showing aspects of merchant vectors and customer vectors in accordance with one embodiment of the invention;

FIG. 20 is a graph showing aspects of derivation of principle components in accordance with one embodiment of the invention;

FIG. 21 is a diagram showing aspects of an affinity model in accordance with one embodiment of the invention;

FIG. 22 is a flowchart showing a modeling process in accordance with one embodiment of the invention;

FIG. 23 is a table showing examples of variables, attributes and/or preferences that can be tracked in accordance with one embodiment of the invention;

FIG. 24 is a diagram showing aspects of zip-code marketing in accordance with one embodiment of the invention;

FIG. 25 is a diagram showing further aspects of zip-code marketing in accordance with one embodiment of the invention;

FIG. 26 is a graph showing illustrative aspects of zip-code marketing in accordance with one embodiment of the invention:

FIG. 27 is a further graph showing illustrative aspects of zip-code marketing in accordance with one embodiment of the invention;

FIG. 28 is a flowchart showing the application of transaction-derived demographics in a prospect solicitation model in accordance with one embodiment of the invention;

FIG. 29 is a flowchart showing a process relating to spending profiles derived from model-based clustering in accordance with one embodiment of the invention;

FIG. 30 is a flowchart showing a further process relating to spending profiles derived from model-based clustering in accordance with one embodiment of the invention;

FIG. 31 is a flowchart showing the use of spending profiles in accordance with one embodiment of the invention;

FIG. 32 is a flowchart showing processing using demographic data in accordance with one embodiment of the invention; and

FIG. 33 is a further flowchart showing processing using demographic data in accordance with one embodiment of the invention.

### DETAILED DESCRIPTION OF THE INVENTION

Hereinafter, aspects of the systems and methods for processing customer purchase information in accordance with various embodiments of the invention will be described. As used herein, any term in the singular may be interpreted to be in the plural, and alternatively, any term in the plural may be interpreted to be in the singular.

The systems and methods of the invention are directed to the above stated problems, as well as other problems, that are present in conventional techniques.

As described in detail below, the systems and methods of the invention use customer purchase information to generate a wide variety of data that may be used in a variety of applications. In particular, the systems and methods of the invention generate data that may be used in marketing efforts, such as to identify persons or populations to target.

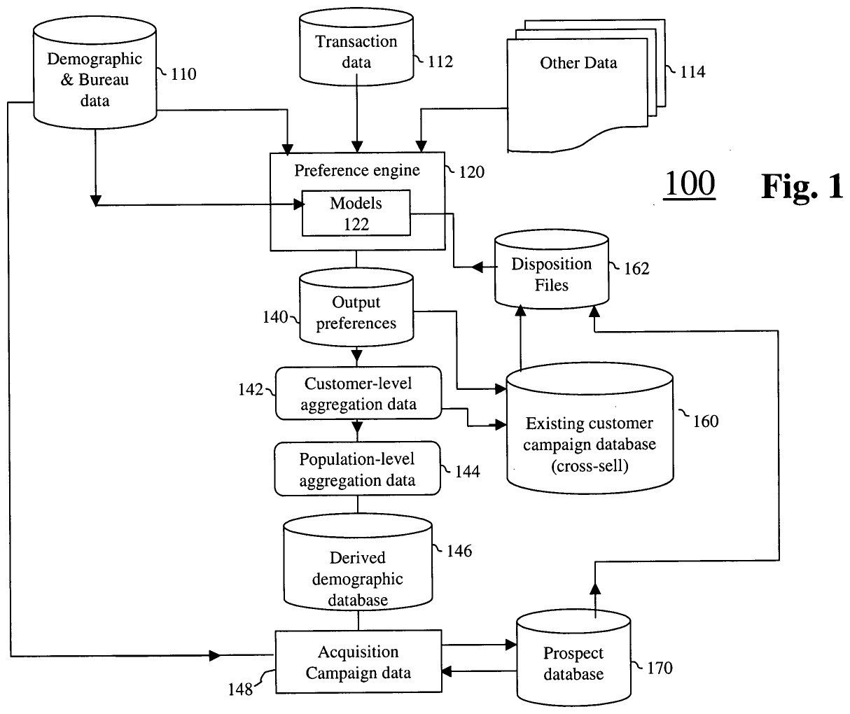

FIG. 1 is a block diagram showing a processing system 100 in accordance with one embodiment of the invention. The processing system 100 may be used to implement the various processes described below. Alternatively, some other suitable processing system might be used to perform the various processes described below.

As shown in FIG. 1, the processing system 100 includes a preference engine 120. The preference engine 120 performs a wide variety of processing as described below. The preference engine 120 utilizes suitable models 122. As shown, the preference engine 120 utilizes data from a variety of sources. In accordance with the invention, the preference engine 120 in particular uses data obtained from customer purchase information or transaction records, i.e., transaction data 112. The transaction data 112 may be obtained from transactions dealing with a variety of transaction mechanisms, including in particular payment mechanisms such as credit card and debit card transactions. As used herein “transaction data” or “customer transaction data” means transaction information between customers and merchants resulting from the use of any of a wide variety of transaction mechanisms, including a credit card, debit card, checks, and electronic transactions (e.g. ACH (Automated Clearing House) or internet), for example.

As used herein, the term “preference engine” means any of variety of processing components to perform the various processing of the different embodiments of the systems and methods of the invention as described herein. Accordingly, a “preference engine” of the invention may include a model or a group of models used collectively. Further, for example, the “preference engine” of the invention might utilize the systems and methods as described in U.S. Pat. No. 6,505,168 to Rothman et al., issued Jan. 7, 2003, which is incorporated herein by reference in its entirety.

Various data is used by the invention, as described above. However, in addition to the above mentioned data, the preference engine 120 also uses data from other sources, collectively shown as other data sources 114 in FIG. 1. The other data sources might relate to address changes, customer disputes, travel data, call center records, chargebacks, other non-monetary transactions and/or other data related to other customer events. Further, the preference engine 120 might use demographic and bureau data 110, i.e., such as from the credit bureaus. However, it should of course be appreciated that the particular end use of information derived from data input into the preference engine 120 should be considered in determining which data is used in the processing. That is, the confidential nature of demographic and bureau data 110 might limit the end uses of derived data.

As described below, the models 122 generate output preferences 140 based on the various data that is input into the preference engine 120. In accordance with one embodiment of the invention, it is appreciated that the preference engine as described in U.S. Pat. No. 6,505,168 may be used in implementation of the methods of the invention. However, the invention is not limited to use of the preference engine as described in U.S. Pat. No. 6,505,168. Rather, other processing using suitable models may be used in lieu of the preference engine as described in U.S. Pat. No. 6,505,168.

In further explanation of FIG. 1, the output preferences 140 may be used to generate customer-level aggregation data 142, i.e., data aggregated at the customer level. Data aggregated at the customer level might be aggregated based on customers, based on accounts and/or based on households, for example. Alternatively, or in addition to, the output preferences 140 may be used to generate population-level aggregation data 144.

In accordance with one embodiment of the invention, the result of the processing of FIG. 1 is the generation of a derived demographic database 146. Further aspects of the derived demographic database 146 and processing using demographic data are described below.

The data disposed in the derived demographic database 146 may then be used in acquisition campaign data 148, i.e., to perform acquisition campaigns. As shown in FIG. 1, the processing system 100 further includes a prospect database 170, i.e., what might in other words be called an acquisition campaign database. The prospect database 170 may provide data to be used in a particular acquisition campaign data 148. Alternatively, or in addition to, the prospect database 170 may input data flowing from a particular acquisition campaign. For example, this data might relate to direct marketing for a particular product or to a new group of prospective customers. In contrast to performing acquisition campaigns, the processing system 100 may also be used to implement existing customer campaigns. As shown in FIG. 1, the existing customer campaign database 160 may be populated with data to conduct such existing customer campaigns using suitable models. For example, the existing customer campaign database 160 may be used to effect cross-sell campaigns.

It should be appreciated that information flowing from a particular marketing campaign or effort is often useful in future marketing efforts. Accordingly, the processing system 100 of FIG. 1 includes a disposition files database. The disposition files database 162 contains response data, and/or campaign history, as well as other desired data from previous marketing efforts. As shown in FIG. 1, the disposition files database 162 may input information from each of the prospect database 170 and/or the existing customer campaigns database 160.

Further aspects of the processing system 100 and the various processes that are performed in accordance with the various embodiments of the invention are described in detail below.

The preference engine 120 as shown in FIG. 1 may utilize a variety of models. The general methodology of a model is of course well known. However, various aspects of modeling, as well as further aspects of the systems and methods of the invention are described below in order to provide a complete disclosure.

A model is a mathematical representation of a behavior, phenomenon, process or physical system. Models are used to explain or predict behaviors under novel conditions. A common objective of scientific inquiry, engineering, and economics is to develop “mechanistic” models that characterize the underlying mechanisms, causal relationships, or fundamental “laws” underlying the observed behavior. In many cases, however, the only relevant modeling objective is empirical performance; consequently, there is no requirement for the model structure to be an “accurate” representation of the underlying mechanisms. Two important classes of empirical (or statistical) models are classifiers and predictive models. Classifiers are designed to discriminate classes of objects from a set of observations. Predictive models attempt to predict an outcome or forecast a future value from a current observation or series of observations. Data generated from a preference engine of the present invention can be used to develop both mechanistic and predictive models of consumer behavior.

A necessary requirement to build any kind of mathematical or statistical model is to find an appropriate mathematical or numerical representation of the data. A feature of the preference engine processing, in accordance with one embodiment of the invention, is that it provides a general architecture to transform transaction data (which includes mixed numerical, categorical, and textual data, for example) into mathematical quantities (“preferences”, “variables,” or “attributes”) for use in models. Modeling applications of these data include predicting response to marketing offers, customer default, attrition, fraud, as well as forecasting revenue or profitability, for example.

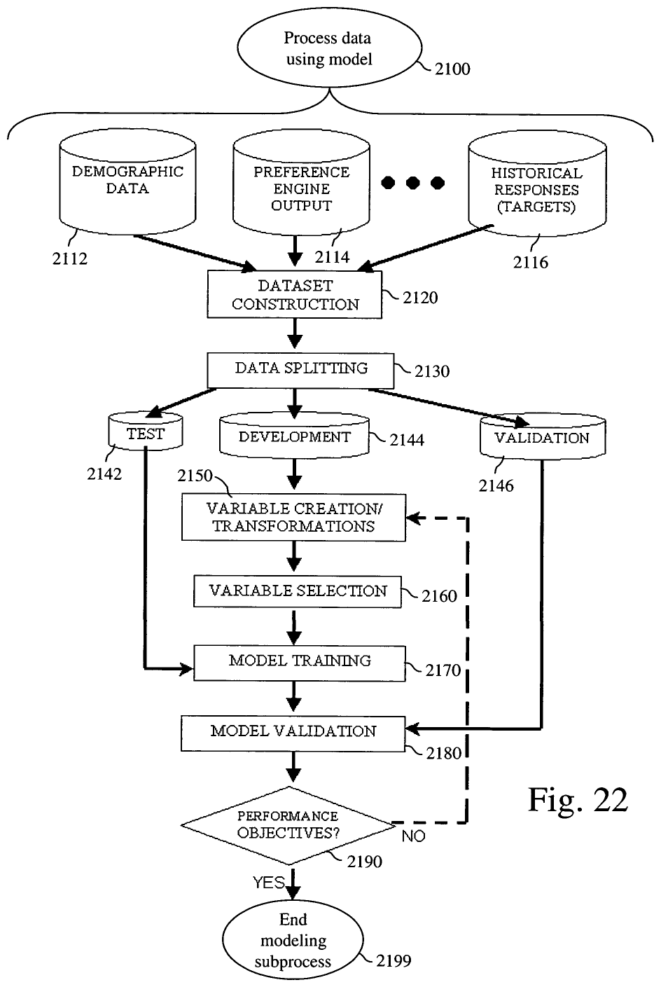

The process of model development depends on the particular application, but some basic procedures are common to any model development effort. These procedures are illustrated schematically in FIG. 22. First, a modeling dataset must be constructed, including a series of observations (“patterns”) and known outcomes, values, or classes corresponding to each observation (referred to as “target” values). In FIG. 22, this is characterized as dataset construction 2120. This modeling dataset is used to build (or “train”) a predictive/explanatory model, which is used to predict outcomes or classify novel (or unlabelled) patterns. Model predictions are often referred to as scores, and the process of generating predictions for a set of records in a data set is called scoring. Model development is an iterative process of variable creation, selection, model training, and evaluation. For illustrative purposes, a detailed example of the model building process is given below for a particular application. The objective in this example is to predict the likelihood that an individual will respond (accept) to a product solicitation.

Hereinafter, aspects of dataset construction will be described. In dataset construction, the objective is to pool all available, relevant information. The first step in the modeling process is to assemble all the available facts, measurements, or other observations that might be relevant to the problem at hand into a dataset. Each record in the dataset corresponds to all the available information on a given event. As shown in FIG. 22, this information might include demographic data 2112, preference engine output data 2114, and historical responses 2116.

With regard to the definition of model objective and target values: in order to build a predictive model, one needs to have established “target values” for at least some records in the dataset. In mathematical terms, the target values define the dependent variables. In the example application of targeted marketing, targets can be set using observed historical response data from a previous campaign (a record is “true” if the individual responded to the offer, false otherwise).

Hereinafter, aspects of a “training pattern” or exemplar will be described. Each pattern/target pair is commonly referred to as an exemplar, or training example, which are used to train, test and validate the model. What constitutes a pattern exemplar depends on the modeling objective. That is, the pattern value and the target value of a record have to be matched for the same entity. For customer-level predictions, all account-level or transaction-level data (transactions, demographics, customer-service center interactions, etc.) are pooled together into a customer-level database. For a transaction-level model, an exemplar consists of all transaction activity on an account up to and including the transaction to be classified. In principle, then, an account with several hundred transactions could be used to generate several hundred examples, as long as the target outcome of each transaction is known.

In accordance with one aspect of the invention, it is appreciated that merging data techniques may be utilized in the practice of the various embodiments of the invention. That is, it may be needed or desired to retrieve data from multiple data sources. As a result, the data may be merged. Records derived from two or more data sources or data sets might be matched using one or more data keys common to both records, i.e., such as using name and address, account numbers, etc. For example, “name and address” matching might be used to merge information from multiple databases. Further, known algorithms might be used to match records, i.e., such as to realize the “ten” and “10” are the same in a particular address, for example. In accordance with some embodiments of the invention, records that cannot be matched are either discarded or kept as incomplete exemplar. It is to be appreciated that some method or decision logic may need to be developed to resolve instances where there are multiple matches or duplicate records. With regard to understanding the data, the distribution of each relevant variable is studied, such as the value range (minimum, maximum), the value density, the special values, etc. Based on the purpose of model prediction, some variables conflicting to the fair lending requirement may not be allowed to appear in the final model, for example. These variables are initially blocked out from the data.

The implementation of models typically includes data splitting, as shown in step 2130 of FIG. 22. Data is typically split to perform model training (development) 2144, testing 2142 and validation 2146. In further explanation, most model development efforts require at least three data partitions, a development data set (data used to build/train the model), a test dataset (data used to evaluate and select individual variables, preliminary models, and so on), and a validation dataset (data to estimate final performance). To serve this purpose, the initial data is randomly split into three datasets, which do not necessarily have equal sizes. For example, the data might be split 50% development, 25% test, and 25% validation.

A model is developed on development data. The resulted performance on the test data is used to monitor any overfitting problems. That is, a good model needs to have comparable performance on both development data and test data. If a model has superior performance on development data to test data, some model modifications need to be made until the model has stable performance.

In order to verify the model will perform as expected on any independent dataset, a modeler would ideally like to set aside some fraction of the data solely for final model validation. A validation (or “hold-out”) data set consists of a set of example patterns that were not used to train the model. A completed model can then be used to score these unknown patterns, to estimate how the model might perform in scoring novel patterns.

Further, some applications may require an additional, “out-of-time” validation set, to verify the stability of model performance over time. Additional “data splitting” is often necessary for more sophisticated modeling methods. For example, some modeling techniques require an “optimization” data set to monitor the progress of model optimization.

A further aspect of modeling is variable creation/transformations, as shown in step 2150 of FIG. 22. In this processing, the objective is precision and the incorporation of domain knowledge. Raw data values do not necessarily make the best model variables due to many reasons: data input errors, non-numeric values, missing values, and outliers, for example. Before running the modeling logic, variables often need to be recreated or transformed to make the best usage from the information collected. To avoid the dependence between development data, test data and validation data, all the transformation logic will be derived from development data only.

In conjunction with transforming the variables as desired and/or as needed, the modeling process includes the step 2160 of variable selection. Thereafter, the model development may include training of the model 2170 in conjunction with testing of the model. This may then be followed by model validation.

The results of the model validation 2180 will reveal whether performance objectives 2190 have been attained based on the current state of development of the model. As shown in FIG. 22, if the performance objectives have been attained, then the modeling process is terminated in step 2199. Alternatively, the performance objectives may not have been attained. As a result, further development of the model is required. Accordingly, the process of FIG. 22 may return to step 2150 so as to vary the variable creation or transformations so as to yield better performance.

Hereinafter, aspects of data cleaning will be described. One aspect of data cleaning is addressing missing values. Oftentimes, the values for one or more data fields in a record are omitted or missing. However, the fact that a data value is missing, in and of itself, might be indicative of a systematic error in reporting, recording, or other process; hence, great care must be taken to find the ‘best’ method for imputing missing values (Sade, W. S. “Prediction with Missing Inputs,” in Wang, P. P. (ed.), JCIS '98 Proceedings, Vol II, Research Triangle Park, N.C., 399-402, 1998. If the missing value is a rare event, incomplete records could be eliminated from the training set. However, depending on the quality of the data, there may be very few records that are complete. Furthermore, as a practical matter, a model should be robust enough to the contingency that certain data fields may not be available for scoring a new pattern. In many cases, a missing value might readily be replaced with the average value found in the population at-large (population mean or median value). In other words, unless there is a real observation of this value, it is best to assume it is representative of the general population; such an assumption should be tested before implementing this solution. An alternative approach is to attempt to impute (interpolate or estimate) the missing value, from the target variable in the data record.

In modeling, some values may be treated specially. That is, some derived variables may have a special value indicating certain meanings. For example, the payment ratio of payment over balance is not derivable if balance is zero. Thus, an out-of-range special value is given to represent this situation. Other common errors found in raw data include invalid ZIP codes, birthdates, etc. The main approach to treat special value issue is to replace it with a valid value by interpolating from the relationship with target variable.

Other aspects of modeling relate to “outlier value treatment.” The extreme value of a variable may result in some bias or inaccuracy of model prediction and performance. Thus, care must be taken in the treatment of outliers before entering the modeling stage. The most common method on outlier treatment is to cap the extreme values to certain boundary. Sometimes, the boundary is set as a very high quantile from the variable distribution study.

Hereinafter, aspects of data transforms will be described. With regard to numeric data, raw data that is already in numerical form can be used directly as inputs to a model. However, transformations are often necessary to fully exploit the value of the information. For example, calendar dates (such as month of year) might be useful to capture seasonal patterns, but in general dates are better transformed into a temporal variable (such as “Customer Age,” rather than “Date of Birth;” or “days since last purchase,” instead of “Date of Purchase”). Variables with bimodal distributions with respect to the dependent variable cannot be fully exploited by linear models. For example, the probability of fraud is higher for very large transaction amounts as well as very low transaction amounts. In such cases, it is desirable to either create a secondary variable (Low$==“amount<$5”) or transform the raw variable into a prior probability using a look-up table (e.g. P(fraud|amount). In some cases, it is useful to linearize continuous variables that have highly skewed distributions. For example, transaction amounts have a natural, Lognormal distribution (purchase amount typically has a Normal, bell-shaped, distribution on a logarithmic plot). For some applications, therefore, model performance or stability may be improved by using the logarithm of the transaction amount, rather than the raw value. More generally, continuous variables can be linearized using binning algorithms, which classify all values into discrete categories. Commonly used algorithms include fixed (e.g. deciling splits the value into 10 categories, lowest to highest 10%), variable binning, or Weight-of-Evidence (WOE) transforms (based on information metrics). WOE transformation breaks down a variable's whole value range into several distinct bins and replaces the raw values within a same bin with a constant multiple of log odds, i.e., a logrithm of the odds ratio. The algorithm of WOE ensures the linearity relationship between the transformation and target binary variable.

With regard to categorical data, binary data fields (Yes/No, Male/Female, etc.) can be transformed directly into binary logical (0/1) variables, although sometimes special coding may be required for missing values. High-dimensional categorical data fields, such as Standard Industry Category (SIC) codes, or ZIP codes, can be transformed in a number of ways. For example, ZIP codes could be mapped using a look-up table to a geographical or distance metric (“Miles from home”, or “distance from previous transaction,” and so on). Another useful transform is to calculate a lookup table, which is keyed on the categorical variable. The look-up table returns the likelihood of response given this value. Possible embodiments of this method include, creating a conditional probability table (e.g. P(response|ZIP), a Log-Odds probability table (useful for logistic regression models, or Log(odds of response), or Weight of Evidence (WOE) transforms, for example.

With regard to textual data, when textual data is limited to single words or short strings of words (as in the merchant descriptor field of a transaction), textual data can be considered a very high dimensional categorical variable. However, a small amount of effort can greatly reduce the variability in these data. A great deal of text processing is implemented in the preference engine, in accordance with one embodiment of the invention while creating preferences, as described in U.S. Pat. No. 6,505,168. For example, a preference designed to detect spending on golf, might look for a handful of keywords in the merchant description (“GOLF”, “19^{th} HOLE”, “LINKS”, “DRIVING RANGE”, etc.) Even higher fidelity can be achieved by limiting this keyword search only to merchants with golf-related industry category codes, such as those for golf courses, country clubs, sports accessories, and miscellaneous government services, i.e., where many municipal and military golf courses are classified.

Free form textual data is much more problematic. However, many tools are available to process these data. Natural language processing exploits the natural structure of language (grammar and spelling rules), to develop heuristics for reducing the dimensionality of and processing natural language, such as stemming words to their roots, correcting common misspellings and abbreviations, eliminating words with low information contents (e.g. “a,” “the,” ‘very,” pronouns, adverbs, etc.), and so on. To detect whether a document is related to a specific topic or interest, one might use keyword searches, attempting to match documents with a table of highly topic-specific keywords. Words can be grouped using domain knowledge or a built in thesaurus. Furthermore, there are a number of methods for clustering words or documents empirically, including co-occurrence clustering and Latent Semantic Indexing (Deerwester, S., Dumai, S T., Furnas, G W., Landauer, T K., and Harshman, R. Indexing by latent semantic analysis. J. Am. Soc. Inf. Sci. 41, 6, 391-407, 1990). More complete discussion of text processing can be found in Baeza-Yates & Ribeiro-Neto, Modern Information Retrieval, Addison-Wesley, Wokingham, U K. 1999, for example.

With regard to temporal or time series data, raw time series data, even when already in numerical form, may not always be the most useful form to use as inputs to a model. For example, for discriminating seismic signals, the Fourier transform (or power spectrum in the frequency domain) proved to be a much better data feed into a neural network model than the temporal sequence (displacement amplitude vs. time) (Dowla, F U, Taylor, S R, & Anderson R W. Seismic discrimination with artificial neural networks: Preliminary results with regional spectral data, Bull. Seismo. Soc. Amer. 80(5): 1346-1373, 1990). Methods of transforming temporal (or time-series) data are ubiquitous in engineering and econometrics, but have only recently been applied to transaction data. Among the many methods that can be adapted to transaction data are: moving averages, signal processing techniques, and ARIMA models. Time series can also be used to update internal state estimates with each new data point (as with Kalman filtering and hidden Markov models). Any number of these methods can easily be implemented within the preference engine design. Illustrative examples are described below.

In accordance with further aspects of the invention, recency, frequency, and other state variables will hereinafter be described. A common issue with demographic data sources is: “How old is this data?” In other words, we don't want to know that a customer had a baby in the last 2 years. Rather, we want to know if they had a baby last month. If preferences were only designed to detect total transaction amount in the last 12 months, valuable temporal information would be obliterated, since it would not distinguish the timing of events within a full year. In predicting default risk, for example, the predictive value of monthly revolving balance or delinquency events are an exponentially decaying function of the number of months preceding the current date, with data more than 6 months old nearly meaningless, statistically. The time scale for detecting recent movers, vacations, or fraud poses similar problems.

As described above, in order to make more useful modeling variables for profiling consumer spending behavior the sequential transaction data can be compressed into low-dimensional state estimators, i.e., over a period of months, for example. Three first-order state variables commonly tracked in transaction data are the average transaction volume (dollars spent on a particular class of merchant), transaction frequency (transaction rate), and “recency” (the rate of change of transaction frequency). These three variables are commonly used in demographic databases, and are commonly referred to as RFM data (recency, frequency and monetary).

There are several working definitions of recency. One might be the instantaneous rate of change of frequency, which can be implemented with a Kalman filter (Kalman, R E A New Approach to linear filtering and prediction problems. Trans. ASME—J. of Basic Engineering, 82(D):35-45 1960), but is a bit complicated. A crude, but effective, approximate can be accomplished with low-pass filter, or “exponential moving average”:

recency(Q)=Σᵢ₌₁^{N}Q(Tᵢ)e^{-Δt/τ},
where the quantity, Q, associated with transaction, decays exponentially (time constant, τ) as a function of its age, Δt.

Such quantities are exceptionally valuable in event detection problems, i.e., detecting based on significant changes in behavior, as occurs during fraud, vacations, or marriage. For many purposes, these three basic quantities are sufficient. Tracking of even higher-order variables (such as event co-occurrence, seasonality, and periodic payment detectors) is also possible. For example, one variable that may be tracked in a preference engine of the invention is a recurring payment detector, which looks for periodic transactions at the same merchant over time.

Hereinafter, aspects of normalization will be described. For some modeling techniques, the actual value ranges for some variables could be 0 to 1 (for binary variables) or 0 to $1,000,000 for transaction amounts. This can be problematic for some classes of models. As a result, raw numerical patterns are normalized before being used as inputs to the model. Common techniques include Weight of Evidence, linear normalization (converting all values into a range from 0 to 1), Z-scaling (transforming all values into the number of standard deviations from the population mean, or X^{T}=(x−μ)/σ), and binning algorithms, for example.

Hereinafter, aspects relating to derived variables and feature detectors will be described. Linear models are not able to capture non-linear relationships between variables (such as ratios or products of variables); consequently, a modeler will often design variables to capture specific, known nonlinear relationships. Variables can also be to capture relationships or attributes of particular interest to application at hand, based on experience or specific domain knowledge of the problem of interest. For marketing applications, important variables would include purchase channel affinity and indicators of major demographics. For fraud detection, many of the raw transaction variables (such as dollar amount or merchant type) are not particularly strong, in and of themselves. For example, a purchase amount of $5,000 is not particularly risky, if the transaction is with a large appliance retailer. However, the purchase of a major appliance at a store located 3,000 miles from the customer's home address is very suspicious. Hence a modeler familiar with the fraud behavior would likely design to test a specific variable, designed to capture the interactions between several variables (transaction amount, Merchant Category Code (MCC) or Standard Industry Category (SIC), merchant ZIP code, customer ZIP code), which could be extremely non-linear.

Complex algorithms, decision logic, or even statistical models need to be developed to ensure the precision and accuracy of derived variables. For example, an important variable of general interest to the payment service industry is the number of recurring payment transactions. An algorithm designed to detect recurring payments would need to detect periodicity in the transaction history.

With regard to imputed demographics, preference engine variables can be also be models themselves, designed to impute major demographic factors, such as age, income, home ownership, marriage, birth of a child, and wealth, for example. These, higher-order, preferences, could be used in turn as input variables to more complex models. External data sources could then be used to validate the accuracy of these indicators. For example, one could use the customer's birth date (reported on an application form) to validate a prediction of cardholder age.

With regard to event detection, of particular interest to many applications is detection of major life events including marriage, birth of child, and/or home purchase, etc., for example, since these events usually precede significant changes in spending patterns. For example, to detect the instance of children entering college, a variable can be created to identify college exams (SAT Registrations), application fees, or tuition payments. To predict the event of a marriage (as opposed to marital status), one would look for indicators of the changes in spending behavior. Hence, a variable measuring the ratio of long-term to short term spending is a logical candidate for detecting these events. Another example would be to create a variable to detect an increase in spending at toy and maternity stores, to predict the birth of a child in a customer's household.

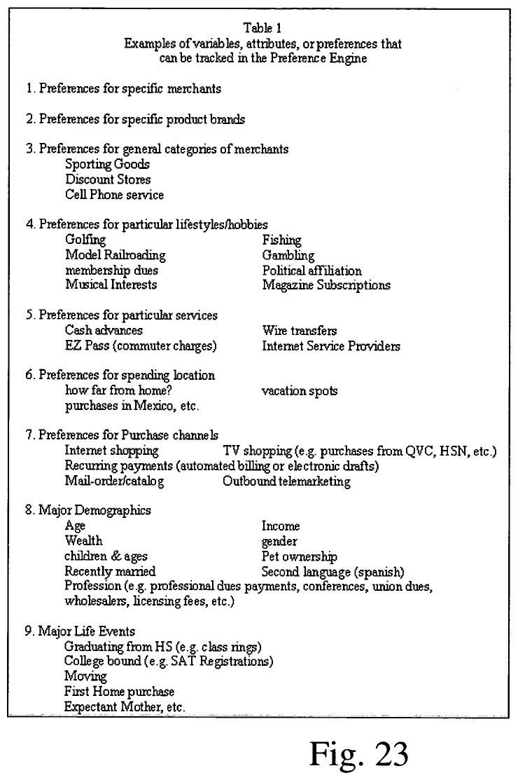

Additional examples of variables designed to detect purchase channel affinity, major demographics, life events, and so on are given in FIG. 23.

Hereinafter, further aspects relating to dimension reduction and noise reduction will be described, the objectives being performance and robustness. The number of possible input patterns used to build a model is literally infinite. There is rarely sufficient data to build a model on raw datasets to account for all the possible combinations of values in a statistically exact way. For example, just one raw data variable, merchant ZIP code, has over 7,000 possible values. The conjunction of this variable with a binary variable, such as cardholder gender (M/F) yields 10,000 possible combinations of values, or patterns. An attempt to build a model directly off of raw data would likely fail, not because the model could not learn to capture the associations in the development dataset, but because the model would not generalize to novel patterns. In other words, such a model would have “memorized” the specifics of each case in the development set (“All females in ZIP code 12345 will respond to the offer.”). This phenomenon is commonly referred to as model “overtraining,” “overfitting,” or “learning the noise.” Steps need to be taken throughout the model building process (variable creation, variable selection, and model training) to prevent overfitting. In addition, several “dimension reduction” techniques can be applied to sets of variables, to systematically force specific variables into higher-level, more general categories. Methods of dimension reduction include, but are not limited to, cluster analysis, principal component analysis, factor analysis, independent component analysis, collaborative filtering, hidden Markov models, statistical smoothing, and mixture models.

Several data-driven techniques are particularly well suited for application to preference engine data. preference engine data can be represented as a large matrix, with N records (one for each customer or account) and P columns (one for each preference, or variable generated by the PE). Given the large number and variety of attributes that can be tracked by a preference engine, this matrix tends to be sparsely populated (for any given individual, only about 2% of the thousands of attributes/preferences tracked have non-zero values). Furthermore, since data in the preference engine is stored hierarchically (many preferences are subsets of higher-order preferences), several of the preferences are highly correlated. For example, there could be preferences for purchases at “Clothes Stores,” “Women's Fashion,” “Brand Name Fashion”, and the specific merchant “ANN TAYLOR”. It is reasonable to conclude that there is little value in including all of the thousands of preferences as independent variables in a general, marketing model. But, selecting only one of these four reduces the amount of information in a very crude manner. Ideally, one would like to use the variation in the data to determine how dimension reduction is accomplished. Dimension reduction techniques are designed to find a more compact representation of such high-dimensional data, without substantial loss of information.

Principal Component Analysis (PCA) is a standard and effective dimension reduction technique. Essentially, PCA uses a linear transform to find the “natural” coordinate system for the data. An intuitive example, the “natural” coordinate system for our solar system would place the origin at the Sun, the primary and secondary dimensions would be along the major and minor axes of the elliptic plane (or the planetary orbits), and the third (and least important dimension) would be along the North/South pole. The “best” two-dimensional representation of the solar system then would be a 2-D plane, which would give a reasonably good representation of the orbits of the planets.

The principal components may be computed through singular value decomposition of the original matrix or eigenvalue decomposition of the covariance matrix. The new dimensions are called Eigenvectors, or principal components. The principal components are then rank ordered, according to the amount of natural variance in the data along that dimension (given by the eigenvalues). Dimension reduction is accomplished by eliminating the dimensions with the least variation in the data, i.e., the smallest Eigenvalues.

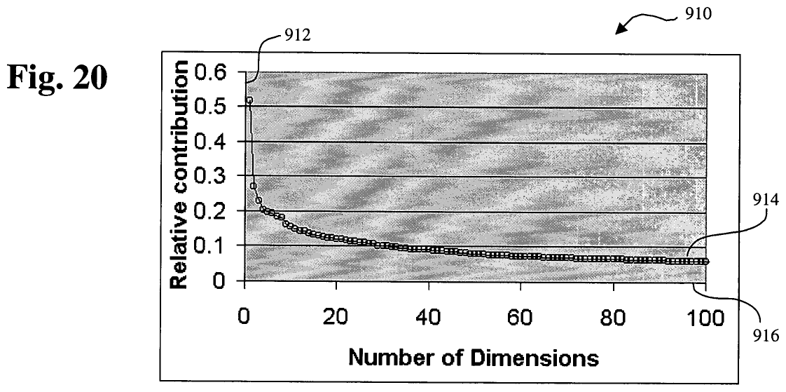

FIG. 20 is a diagram showing further aspects of dimension reduction relating to output of a preference engine in accordance with one embodiment of the invention. That is, FIG. 20 shows a histogram of the eigenvalues of the top 100 principal components, derived from 1,500 dimensional preference engine output. This result indicates that a large percentage of the variation in spending behavior can be captured with a 20-30 dimensional projection of this 1500-dimensional space.

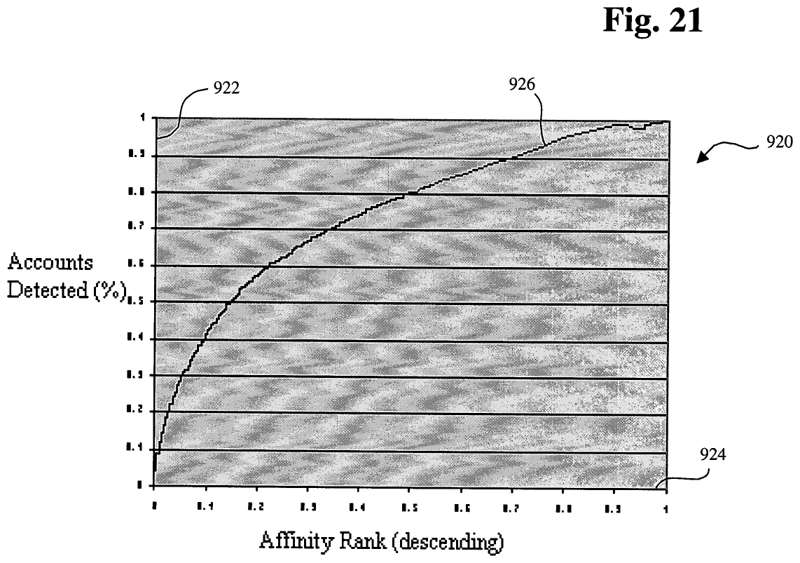

Further, the eigenvalues of the top 100 principal components found in an application of the preference engine is shown in FIG. 21. In one marketing application, for example, a model was built using only the top 2% of the principal components (a 50-fold reduction in the number of variables to be considered in modeling) with no loss in predictive value.

To explain further with regard to FIG. 21, an affinity model was constructed by profiling accounts in the general portfolio versus accounts with an internet-specific credit card. The objective of this exercise was to demonstrate that one could infer what type of credit card a customer had purely from their spending behavior, i.e., no demographic variables were included. A few individual preferences (such as ISP service, internet shopping, etc.) were strong indicators. This particular “affinity model” used only the top 40 principal components to predict the cardholder carried an internet card. Note that although the specific preferences for ISP service and internet shopping are not explicitly included in this model, the information related to web interest is contained in the highest 40 dimensions.

Hereinafter, aspects of PCA for sparse data will be described. In a preliminary version of the PE, there were over 2,000 preferences tracked on 43 million accounts, making calculation of the principal components extremely computationally intensive. However, as already mentioned, only a limited small number of preferences are populated for each account, i.e., the data are sparse. This aspect of PE data can be exploited to greatly reduce the amount of computation required in calculating the principal components of an extremely large matrix.

Sparse matrix techniques (Duff I. S., Erisman A. M., and Raid J. K., Direct Methods for sparse Matrices, Claredon Press, Oxford, 1986) implement matrix operations or algorithms by performing only the computations required by the non-zero elements of the matrix. Considerable savings in time and computer memory are achieved. As mentioned earlier, the principal components may be computed through singular value decomposition of the original matrix or eigenvalue decomposition of the covariance matrix. Sparse singular value decomposition methods are used in information retrieval techniques. For instance, in Latent Semantic Indexing singular value decomposition is usually computed based on iterative methods, such as Lanczos methods or trace minimization (see Berry, M., Large Scale Singular Values Computations, The International Journal of Supercomputer Applications, 1992.)

Because the covariance matrix is very small, especially compared with the number of observations, it is more convenient to work with the covariance matrix and its eigenvectors. The covariance matrix itself is a dense matrix and any standard dense eigenvalue decomposition may be used to compute the principal components. This step is computationally inexpensive considering the size of the matrix (equal to the number of preferences, i.e., less than the 2000).

The computation of the covariance is on the other hand very expensive. If the data are centered, it requires computing a product of a (transposed) matrix with millions of rows by itself. A good approach consists in computing this product as a sum of sparse outer products of its row vectors (the vector of preferences). The average number of preferences (NAVP) by account is typically between 50 and 60. Computing the contribution of an outer product of sparse vector with NAVP non-zero entries requires NAVP×NAVP operations (Duff I. S., Erisman A. M., and Raid J. K., Direct Methods for sparse Matrices, Claredon Press, Oxford, 1986). Thus the total number of operation amounts to a manageable NOBS×NAVP×NAVP, where NOBS is the number of observations (the number of rows of the matrix).

If the data are not centered (and there is no reason to expect that they are), the covariance is more difficult to compute. Subtracting the mean (a dense vector) before computing an outer product leads to a dense vector. The number of operations is then NOBS×NP×NP, where NP is the number of preferences. This is excessive. But one can decompose the product into sum of products that involves the mean vector and the preference vectors. By doing so, we need to compute—on top of the sparse preferences vectors, products of preference vectors by mean vectors for each observation and a single outer product of the mean vector. A product of dense vector by a sparse matrix requires NAVP×NP operations on average. Therefore the total complexity of this approach is NOBS×(NAVP×NAVP+2×NAVP×NP)+NP×NP operations. Finally, it is possible to compute the principal components by sampling the accounts. But the relatively low complexity of the procedure and the massive parallel computer power of today's computer make possible to use the full dataset.

A final step includes computing the principal vectors: the product of the original matrix by the matrix formed by a small number of principal vectors. This is a simple sparse matrix by dense vector operation. Its complexity is sensibly less than the computation of the covariance matrix (see Duff et al. 1986). On the other hand, the principal vectors of all observations can be computed for all observations extremely fast.

Hereinafter, aspects relating to clustering and other co-occurrences methods will be described. A set of observations can sometimes be naturally divided into a certain number of clusters. Each cluster should then be a consistent set of observations that are relatively close to each other. The problem occurs in countless (unsupervised learning) applications. For a survey of these techniques, see (Park, J and IW Sandberg. Universal approximation using radial-basis-function networks. Neural Computation 3:246-257, 1991).

Clustering algorithms are either combinatorial or probabilistic. Combinatorial algorithms typically rely on some similarity, dissimilarity or distance function. Variants of these algorithms depend on the choice of loss or energy function to minimize. For instance, when all variables are of quantitative type and a squared Euclidian distance is adopted as the dissimilarity function, a very popular algorithm is K-means. The assumption of Euclidian space can be relaxed in other algorithms. The K-medoids algorithm, for instance, can work with arbitrarily defined dissimilarity function at the expense of more computationally intensive iterations though.

Probabilistic algorithms are based on a probabilistic model that specify how the data were generated. Finite mixture models provide a convenient general probabilistic method to deal with the data heterogeneity. The parameters of the model are usually estimated by the maximum likelihood principle or by Bayesian methods. This is generally done through an expectation maximization (EM) algorithm. A broad and comprehensive survey of Mixture modeling and fitting technique is given in (McLachlan G., and Peel D. Finite Mixture Models, Wiley Series in Probability and Statistics Section, John Wiley & Sons, 2000). Finite models have become increasingly popular since the EM algorithm considerably simplified the fitting of mixture models. Recent researches (Buntine, W. & S. Perttu. Is multinomial PCA Multi-faceted Clustering or Dimensionality Reduction? Proc. Ninth Int'l. Workshop on Artificial Intelligence and Statistics, C M Bishop & B J Frey (eds.). Soc. For Artificial Intelligence and Statistics, 2003) show the links between clustering of discrete data with mixtures of multinomials and dimension reduction.

Hereinafter, aspects relating to variable selection will be described, which relate to the objectives of parsimony and stability. Models constructed using too many variables often run the risk of overfitting the development data. In general, a model should have much fewer parameters than the number of data points (target examples) used to create the models. Although rarely a computational issue, it is undoubtedly useful to remove variables if they are shown to be redundant, noisy, or useless (in terms of predictive power). Techniques for systematically eliminating such variables are referred to as variable reduction techniques.

Assuming one had access to unlimited response data and computer resources, perhaps the optimal way to select a model from an initial set of N variables would be to build N models, leaving out one variable at a time, and eliminate any variables whose omission either harms or does not improve model performance on a hold-out set. This process could be iterated until a parsimonious model is found. Many variable reduction methods use variants of this “brute force” approach, including evolutionary optimization of models. Care must be taken to ensure the model is not over fit, by either maintaining a final hold-out data sample, or randomly generating a hold-out set for each iteration.

The most effective, practical variable selection procedure for building linear models is stepwise regression, since it systematically tests the incremental contribution of each variable as it is added to a linear model.

Variables that can be used in non-linear combinations with other variables will not necessarily be detected. Hence, for building general, non-linear models, a variety of variable evaluation methods are employed, one of which is usually stepwise regression. Other common methods or metrics used to rank order variables include univariate measures using the divergence, Kolmogorov-Smirnoff (KS) statistic, or information content (Kulback-Leibner information measure). Each of these methods measures some characteristic of the variable that if fully-exploited in the model would have predictive power, individually. Methods used to estimate the incremental value of variables, when used in combination include mutual information criteria, multicolinearity tests, cluster analysis, evolutionary selection, relationship discovery, and sensitivity analysis. Sensitivity analysis is especially useful for evaluating variables for inclusion in non-linear models, since it measures the sensitivity of the model's response to variations in individual variables. In many cases, a modeler may rank variables using several methods, and select the top X variable from each method for the final model.

Hereinafter, aspects of model training will be described. In model training, an objective might be characterized as finding an optimal combination of variables to maximize performance.

The simplest model to build (in terms of model structure and implementation) is a linear regression model. A linear regression model is one type of model that may be used to practice the various embodiments of the invention. This method optimizes the predictive score created from a linear combination of the variables, i.e.:

y=β₀+β₁x₁+ . . . +βₙxₙ=Xβ

where x₁ . . . xₙ are the variables included in the model, and β₀ . . . βₙ are the coefficients (or weighting factors) to be optimized through maximum likelihood method, in this case, is an calculation to find the coefficients, by minimizing an objective function. The most common objective function is the residual sum of squares (RSS):

RSS=(y−Xβ)^{T}(y−Xβ),

The model coefficients can then be found by solving:

β=(X^{T}X)⁻¹X^{T}y

Alternative objective functions can be designed to meet specific business objectives. For example, the relative cost of a misclassification could be incorporated into a cost function, to optimize model operation.

Assuming the model variables selected for inclusion in the model are individually predictive, in most cases, this model should be more predictive than using any one variable alone. Linear regression is best suited for predicting continuous targets. One drawback in using linear regression for predicting binary/discrete response is that the score values are unbounded in a linear regression model and have no direct, empirical interpretation. Hence, the model score can be used to rank-order prospective customers (the higher the score, the more likely to respond), but cannot be directly used to predict the response probability. For this reason, most response models employ a slightly more complicated version of linear regression, called logistic regression, where the goal is to optimize the coefficients for the model:

P(response|X)=P(y=1|X)=exp(Xβ)/(1+exp(Xβ)).

In addition to allowing for the rank ordering of prospects, this model yields a prediction of the odds that a prospect will accept an offer.

With regard to model-based regression, model-based regression techniques attempt to “fit” the data to a particular model structure; in the case of linear regression, the model assumes a linear relationship between the variables and outcome. Other forms of model-based regression modeling might include higher-order terms (e.g. products of variables, as might be used in a Taylor series to estimate any arbitrary, continuous function of many variables), in an effort to capture some of the non-linear relationships between the variables; however, the combinatorial explosion of variables that results makes this approach problematic. Other model-based regression algorithms include Support Vector Machines (Cristianini, N & J. Shawe-Taylor, An introduction to Support Vector Machines and other kernel-based learning methods, Cambridge University Press, 2000)

Further, an alternative modeling approach is non-parametric regression, wherein “universal function approximators” (Cybenko, G. Approximation by superpositions of a sigmoidal function. Math. Control, Signals, & Sys. 2:303-14, 1989.; Park, J and I W Sandberg. Universal approximation using radial-basis-function networks. Neural Computation 3:246-257, 1991) are trained to approximate the functional relationship between the input and output variables. Classes of non-linear models include neural networks (Bishop, C. M., Neural Networks for Pattern Recognition, Oxford University Press, 1995), radial basis functions (Moody J, Darken C J. Fast learning in networks of locally-tuned processing units. Neural Computation 1:281-294, 1989; Park, J and IW Sandberg. Universal approximation using radial-basis-function networks. Neural Computation 3:246-257, 1991), and adaptive fuzzy logic models. These methods theoretically can learn any, arbitrarily complex function, but require sophisticated optimization algorithms or practitioners to find robust, practical solutions.

Hereinafter, aspects of rule-based classifiers will be described. For some applications of preference engine data, the objective of modeling might be to optimize a policy or process. In such cases, the models might take the form of a set of decision logic (If X, then Y; else Z, and so on). Competing methodologies for generating logical (or rule-based) models include decision tree building algorithms (e.g. Quinlan, J. R. Bagging, Boosting, and C4.5 (preprint)), adaptive fuzzy logic and evolutionary programming.

Finally, it should be noted there is no single, best methodology used to optimize all classes of models. For example, neural networks can be trained using a variety of error minimization algorithms, some exact (so-called batch mode), others approximate and incremental (on-line learning). Most optimization algorithms require an additional partition of the dataset (in addition to development, test, and validation), to monitor progress of model training (sometimes referred to as the “optimization set”). When datasets are small, some modelers will opt to take “short cuts”, using the test data set both to validate variables and to train the model. Other modelers might employ “bootstrapping” and “leave-one-out” validation (Dowla, F U, Taylor, S R, & Anderson R W. Seismic discrimination with artificial neural networks: Preliminary results with regional spectral data, Bull. Seismo. Soc. Amer. 80(5): 1346-1373, 1990). Bootstrapping has proven to be a robust method for training neural networks (White, H. A reality check for data snooping. Econometrica 68(5):1097-1126 (2000)), but often leads to overoptimistic results in decision trees.

The above discussion has been provided to describe aspects of modeling, as well as aspects of the invention. Hereinafter, further aspects of the systems and methods of the invention will be described.

In accordance with one embodiment of the invention, a method is provided for the characterization of consumers and merchants with reduced dimension, “Spending Profiles.” To explain, when launching new products or marketing campaigns, a marketer does not have the benefit of historical response data to construct a targeting model. Test marketing, however, need not be conducted on purely random sample populations. Usually, the campaign is targeted at what market research shows to be the expected demographics for the product (ZIP code, age groups, etc.). In a similar vein, the preference engine can be used to create “spending profiles” of individual consumer or households. Indeed, the complete output record for an account gives a highly detailed summary of a cardholder's spending over time. However, the high dimensionality, high noise, and redundancy of such output may make it an impractical choice for profiling. Alternatively, one can characterize a target population by selecting their most distinguishing spending preference. For example, a target population for an Internet Service Provider (ISP) may have unusually high spending on internet purchases, computer equipment, and very low purchase rates at retirement homes. This approach is quite effective for marketing products that have highly specific interests (such as golf equipment).

The systems and methods of the invention also provide for marketing applications of spending profiles, i.e., affinity models. For broader-based products (e.g. hardware stores, small business products, buying clubs, etc.), no particular preference could be expected to “stand out,” statistically. In such cases, low-dimensional representations of an account's preference scores, can be used to create a “Spending Profile” or “fingerprint”, which can be used to match affinities consumers to products, services, and merchants.

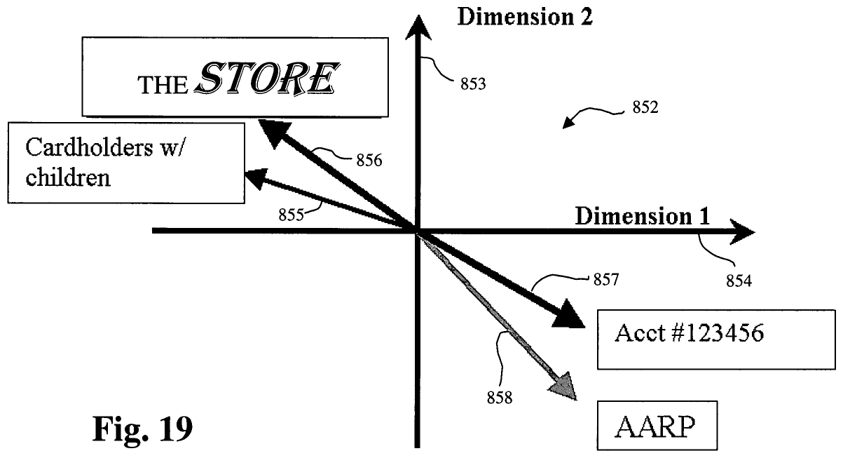

In accordance with one embodiment of the invention, the values of the top 40 principal components for a customer are used to define a 40-dimensional “profile” of his spending behavior. The performance of this model in predicting product affinity is shown in FIG. 21. Alternatively, a consumer's profile could be specified by his degree of membership in 20 general classes, derived from a mixture of multinomial models or cluster membership functions. Likewise, any particular merchant, product, or service can be represented by the vector-average values of all of its customers. The distance between a customer's profile and the merchant's profile measures a customer's affinity to a merchant. The most convenient measure of similarity is the dot product of the two vectors, but other affinity metrics could be devised for specific purposes. A two-dimensional example of customer and merchant profiling is shown in FIG. 19 and discussed below with reference to the flowchart of FIG. 18.

In accordance with a further embodiment of the invention, a mixture of multinomials may be used to predict share of wallet and off-us spending, i.e., spending exercised through another banking entity, for example. To explain, the invention provides a method to analyze people's spending behavior on one credit card to estimate their usage on their other credit card or cards. These other credit cards may or may not be with a particular “subject” bank. Several applications of this prediction immediately follow, such as offering the customer a second card, designed to meet their needs better than their current bank. For example, if the customer use their second card exclusively for gasoline purchases, we can offer them a “gasoline rewards” product.

In accordance with a further embodiment of the invention, preferences may be grouped by account holder. To explain, preferences may represent a partial spending pattern since more than one credit card may be used by the credit card holder. Also, in accordance with one embodiment of the invention, a database will include spending patterns of different credit cards that all belong to the same person. On the other hand, some customers may use a credit card of a competitor. The preferences recorded are in this case an incomplete view of the “true” preferences, i.e., preferences that would have been recorded if all the credit cards of the customer were recorded in the database. The invention as described herein provides a methodology that takes advantage of customers that have all their spending recorded in the database to the ones that have only a small fraction of it.

In accordance with a further embodiment of the invention, preferences of “missing” credit cards may be imputed. Adopting a generative model, one may impute the missing preferences by techniques for missing data. One may for instance fit a generative statistical model. Convenience check gives important information for the model. First, one knows the credit card issuer of the missing credit card. Second, the balance gives information about the volume of missing preferences. Overall, one estimates the share of credit card in the wallet of a customer. The same analysis may be extended to household spending and estimate of share of household.

It should be appreciated that the choice of a particular model (a mixture of multinomial or any other generative model) is not critical. In accordance with one embodiment of the invention, the essential part of the technique is to infer missing data from existing data. That is, the model reflects the fact that preferences in the database are incomplete data.

Hereinafter, aspects relating to mixture models to model customer spending profiles will be described, in accordance with one embodiment of the invention. Mixture models are weighted averages of two or more models (e.g. mixtures of probability distributions) and provide a convenient semi-parametric framework to model the heterogeneity of a probability distribution based on more simple distributions, called component density functions (McLachlan G., and Peel D. Finite Mixture Models, Wiley Series in Probability and Statistics Section, John Wiley & Sons, 2000).

It is proposed to model the frequency of transactions for a certain number of spending categories (preferences). The transaction frequencies capture the interest of a customer for a certain type merchant. The multinomial distribution is the simplest distribution one can think of to model frequency counts. Mixture of multinomial allows the construction of more complex models based on simple multinomial distributions.

Two models with slightly different assumptions are proposed. In a first model, the spending category frequencies are modeled at an account level: account spending are the realized values of independent and identically distributed variables. The model can be interpreted as being generated by the following process. First, an account type is generated according to the mixing weights distribution. Then, spending frequencies are generated by multinomial distributions whose parameters are specified by the account type.

In a second model, the accounts that belong to the same customer are not considered independent anymore. Instead of summing up account frequencies of the same customer, it is proposed to change the mixture model to properly reflect this dependency. This means that the mixing weights are individual specific as opposed to global ones.

The use of mixture of multinomial models with different level of aggregation was first considered for retail transactions (Cadez, I V, P Smyth, E Ip, H Mannila, Predictive profiles for transaction data using finite mixture models. Tech. Report, University of California, Irvine 2001). In the latter, transactions of customer visiting retail stores are used to build predictive profiles. It is proposed to adapt the approach to preferences generated by accounts.

As in their approach, an empirical Bayes approach is used to shrink global estimates towards individual estimates, in accordance with one embodiment of the invention. The number of accounts or the Share of Wallet (SOW) is used as discounting factor and naturally gives attributes a relative importance.

At least three different levels of aggregation are possible including account, individual and household level. It is expected to enhance the accuracy of the preferences at the upper levels. The broader views should increase the overall relevance of preferences and account for the relative share of the wallet.

As in (Cadez et al., 2001), the approach relies on an empirical Bayes methodology and a two stages solution procedure that relies on the EM algorithm. The datasets in the latter reference are significantly smaller than the preference counts recorded in the preference engine. Also, the robustness of solutions experienced may not be observed for our model. We may therefore require larger sample to get accurate solutions.

The preference engine is a database that records the preferences Y={Yᵢ}_{i=1, . . . , N} by N accounts. For each account i, the preferences Yᵢ consist of C category counts Yᵢ=(n_{ic} . . . nᵢₚ) where the counts n_{ic}, c=1, . . . , C indicates how many transactions occurred in the merchant category c.

The assumption underlying a mixture model is that the preferences Yᵢ are randomly generated by K components. Each component represents a typical account behavior regarding to the preferences,

$$p ( {Y}_{i} ) = {\sum }_{k = 1}^{K} {α}_{k} {P}_{k} ( {Y}_{i} )$$

where Pₖ(Yᵢ) represents a specific model for generating counts in an account preferences and αₖ are the mixing proportions or weights. It is further assumed Pₖ(Yᵢ) that follows a multinomial distribution θₖ=(θ_{kb1}, . . . , θ_{KN}):

$$P ( {y}_{i} \vert {θ}_{k} ) = {\prod }_{c = 1}^{C} {θ}_{kc}^{{n}_{ic}} .$$

The likelihood is then

$$l ( Θ ; Y ) = P ( Y \vert Θ ) = {\prod }_{i = 1}^{N} {\sum }_{k = 1}^{K} {α}_{k} P ( {y}_{i} \vert {θ}_{k} ) .$$

When a set of account i∈ [symbol] refer to the same individual l, a simple modification of the likelihood can account for the dependency. If αᵢₖ refers to the individual specific weight, the likelihood becomes:

$$P ( Y \vert Θ ) = {\prod }_{i = 1}^{L} {\prod }_{i ∈ {T}_{1}}^{ } {\sum }_{k = 1}^{K} {α}_{ik} P ( {y}_{i} \vert {θ}_{k} ) .$$

In a Bayesian statistics, one is interested in the posterior probability:

$$P ( Y \vert Θ ) = \frac{P ( Y \vert Θ ) P ( Θ )}{P ( Y )} ∝ P ( Y \vert Θ ) P ( Θ )$$

The prior probability of Θ is the product of independent prior on its parameters α and θₖ

$$P ( Θ ) = P ( α \vert ξ ) {\sum }_{k = 1}^{K} P ( {θ}_{k} \vert γ )$$

where α and θₖ follow Dirichlet distribution of parameter ξ and γ.

Instead of computing a full Bayesian estimate, it is easier to compute the maximum a posteriori (MAP) estimate

$$\hat{Θ} = argmax \{ log P ( Θ \vert Y ) : Θ \geq 0 {\sum }_{C = 1}^{C} {θ}_{kc} = 1 , {\sum }_{k} {α}_{k} = 1 \} .$$

The prior can carry information from a general model to an individual weight specific model (as in Cadez et al., 2001). Also, the number of credit cards is used as a prior in an individual weight model. This introduces a discounting effect: an account reflects a partial spending of a wallet. To compute the maximum of the likelihood of the MAP estimate, the EM algorithm or one of its modern versions may be used.

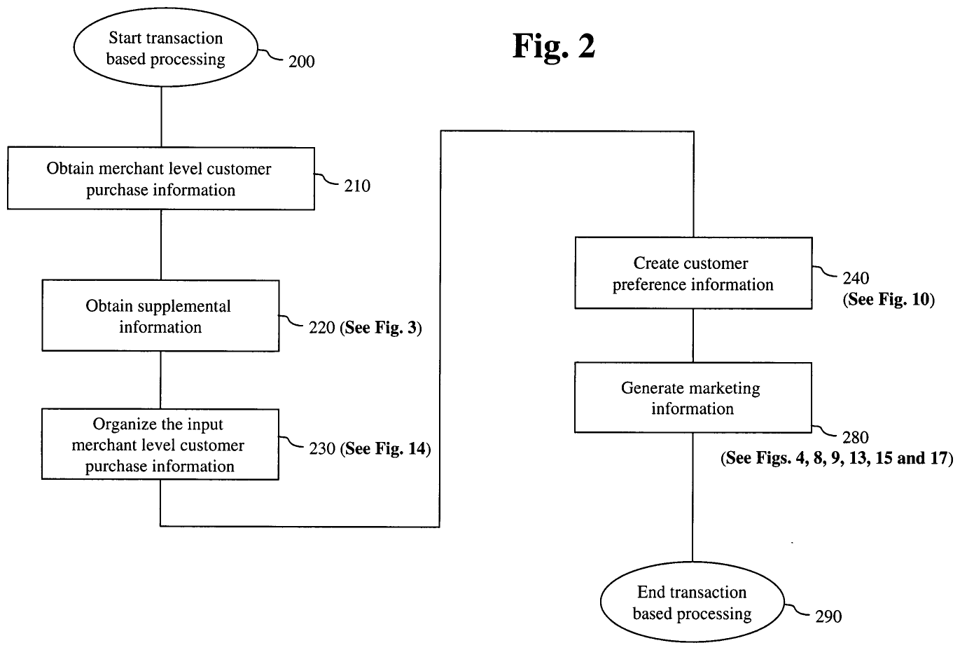

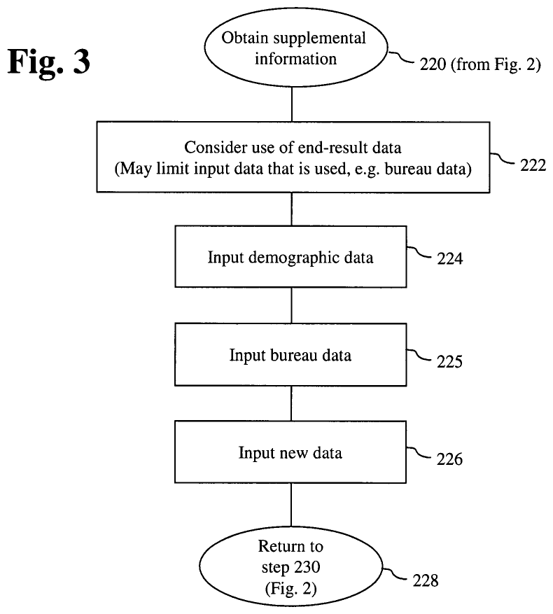

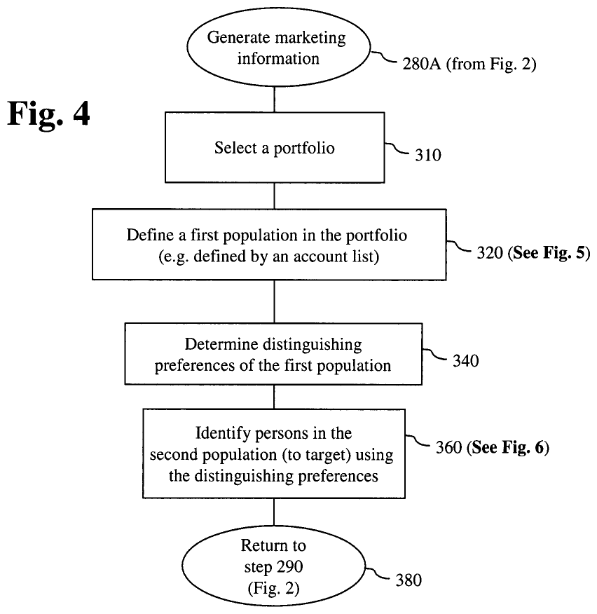

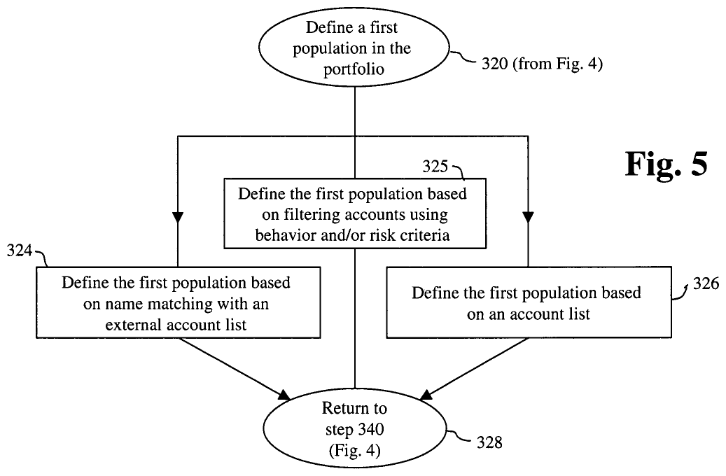

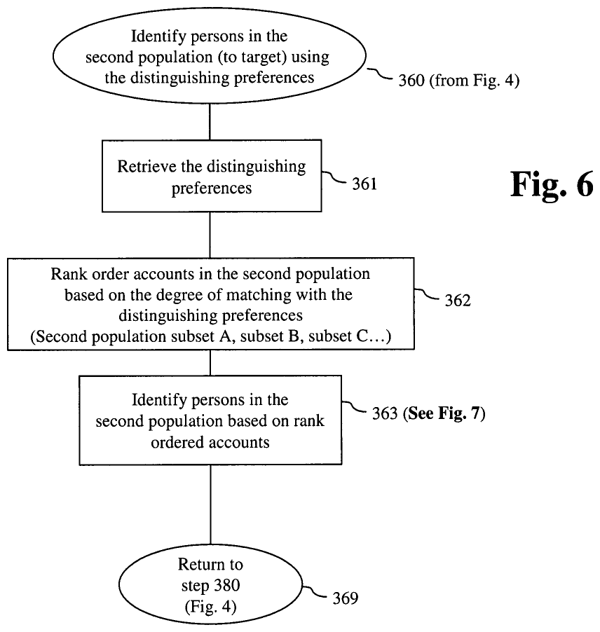

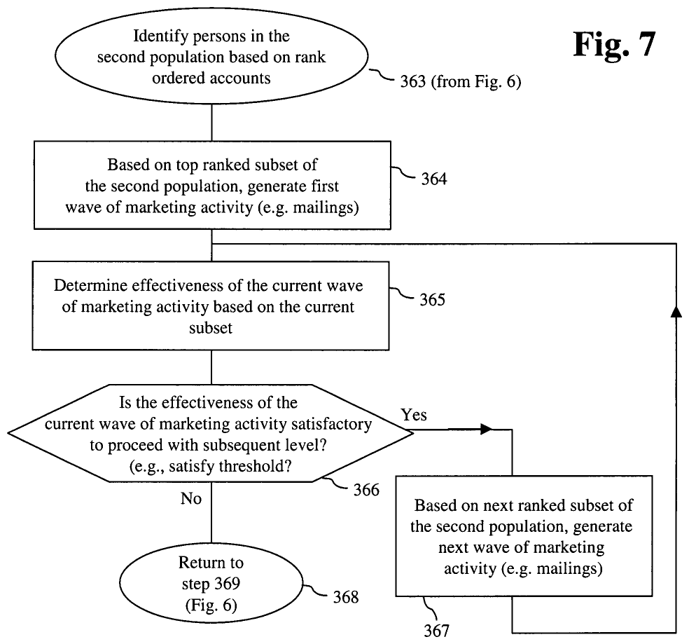

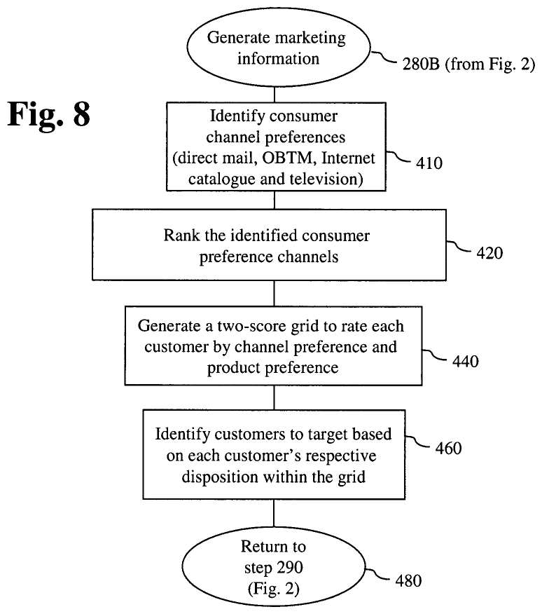

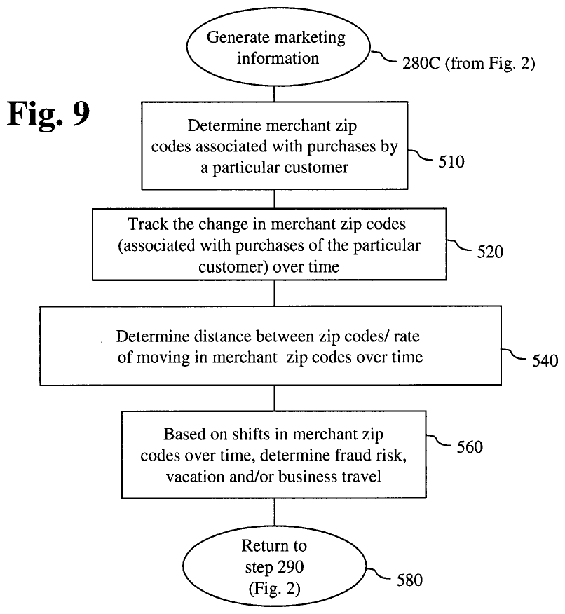

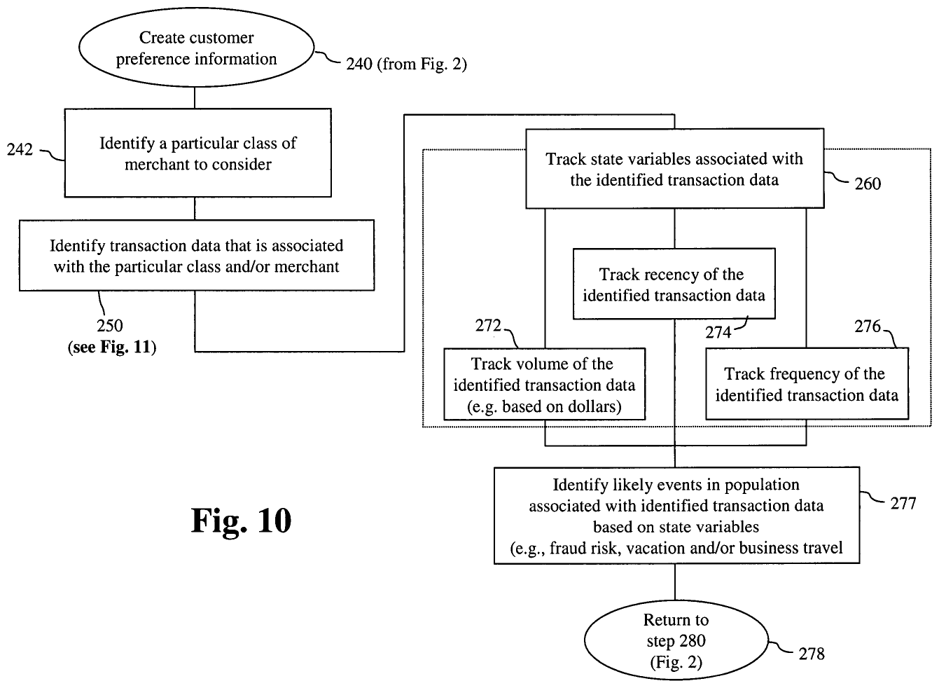

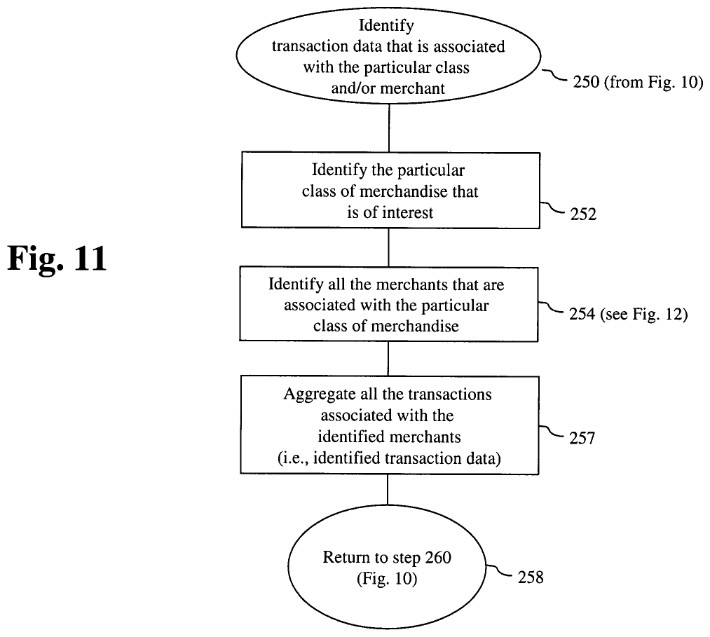

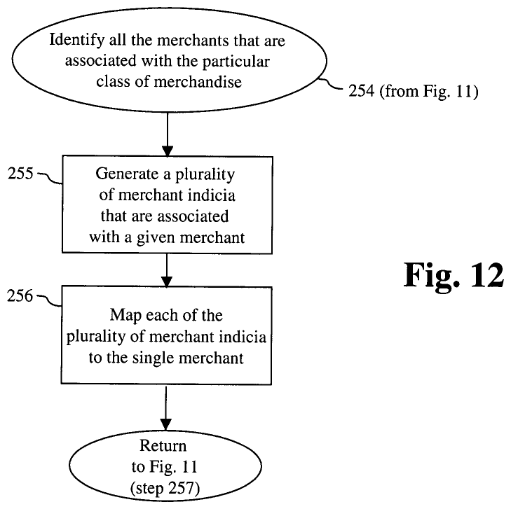

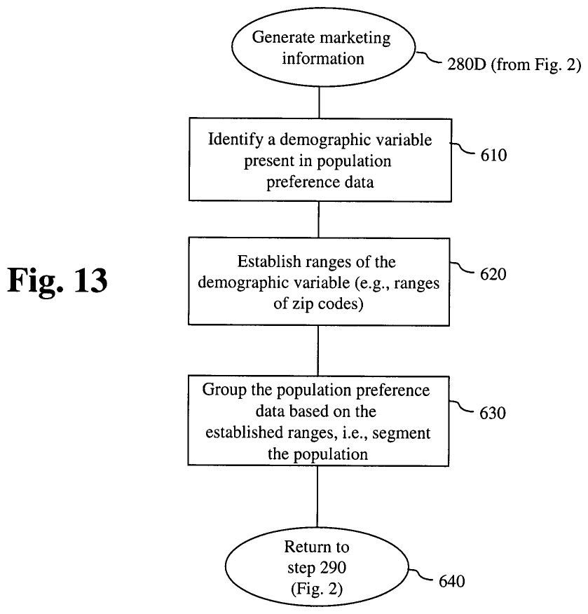

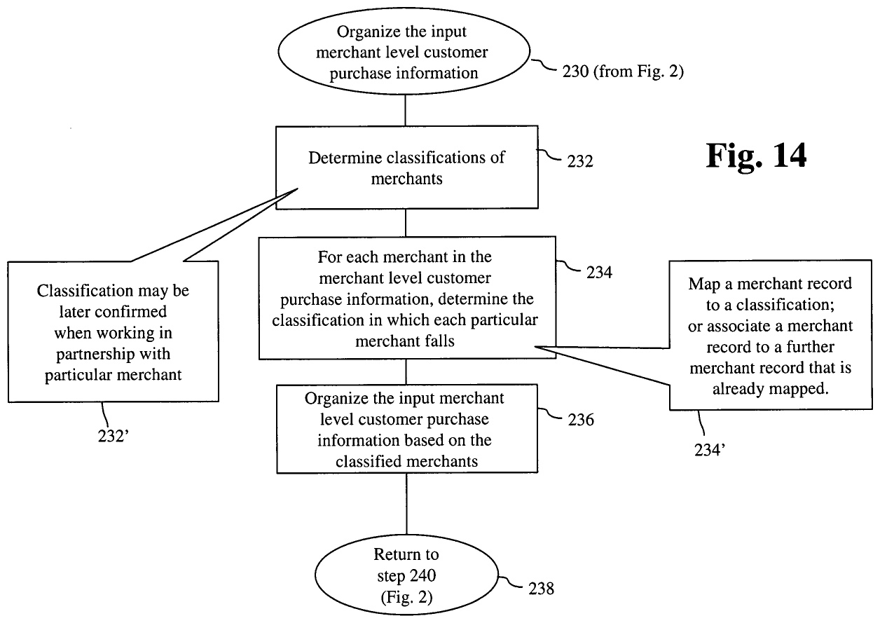

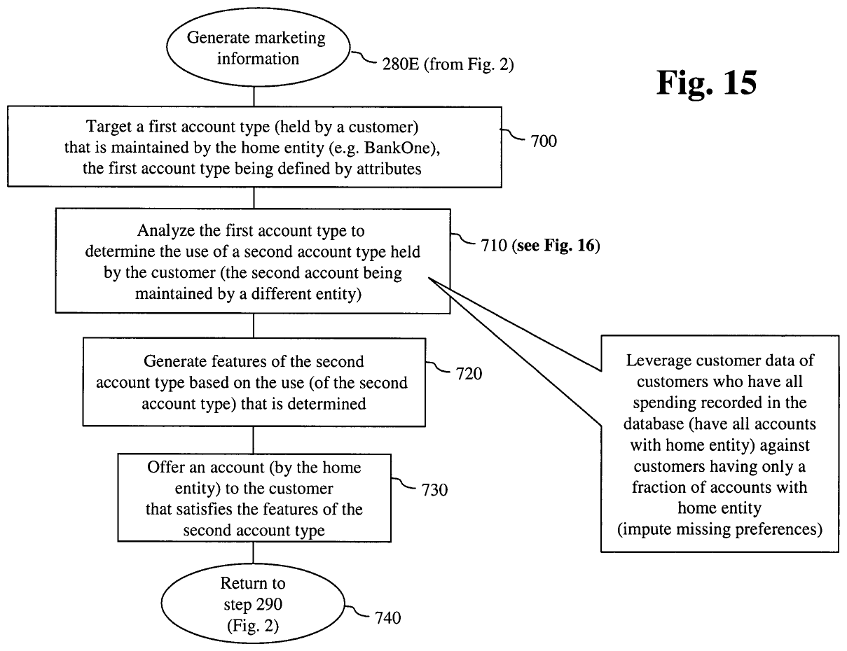

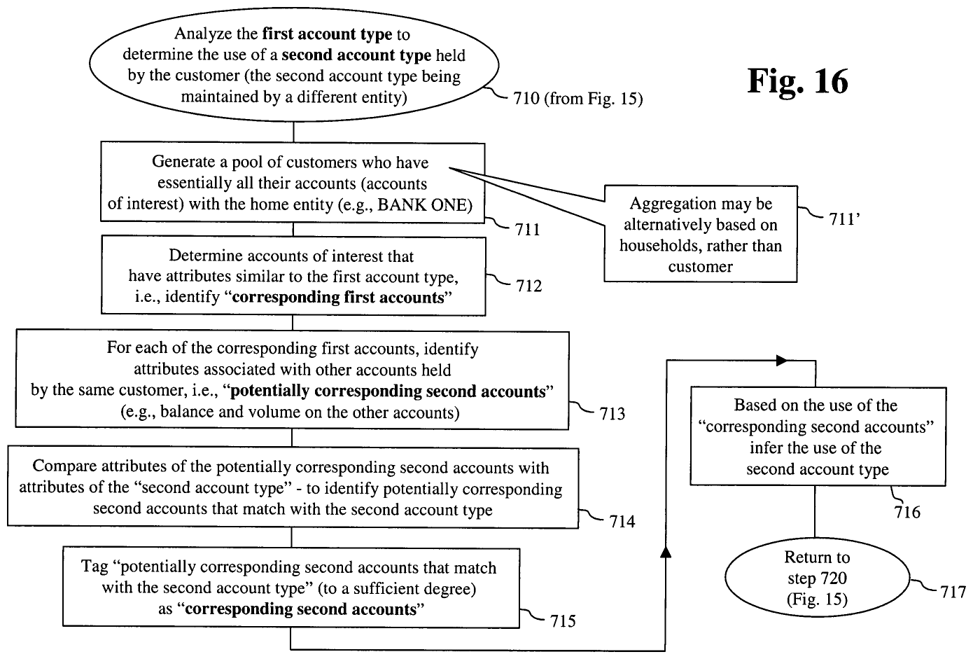

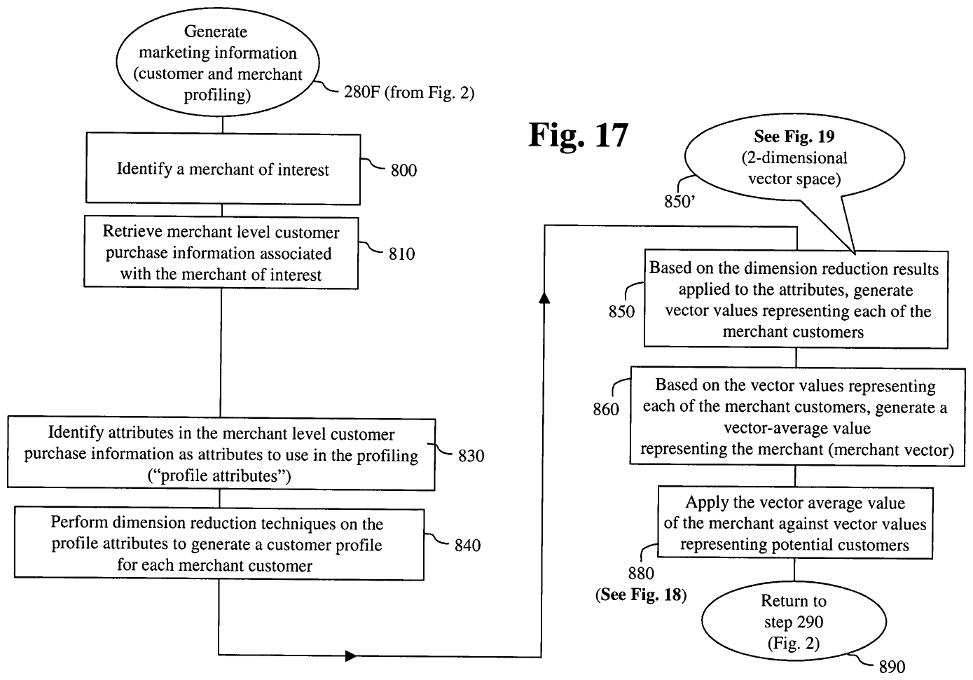

With the above description of modeling in hand, hereinafter, further aspects of the invention will be described turning again to the drawings. FIG. 2 is a highlevel flowchart showing transaction-based processing in accordance with one embodiment of the invention. The method of FIG. 2 may be implemented by the processing system 100 of FIG. 1, for example.

As shown in FIG. 2, a process using the techniques of the invention starts in step 200 and passes to step 210. In step 210, the process obtains customer transaction information. That is, the process retrieves data obtained from customer transactions. Then, the process passes to step 220. In step 220, the process obtains supplemental information. Further details of step 220 are shown in FIG. 3 and described below.

After step 220, the process passes to step 230. In step 230, the process organizes the input customer transaction information. To explain, the organization of the input merchant level customer purchase information may take on a variety of forms, and in particular may involve sorting and classifying the data, for example. This sorting and classifying might be performed by date or based on some other criteria. Further, the organization of the data might involve the aggregation of data and/or the transfer of data from one data set to another, for example.

After step 230, the process passes to step 240. In step 240, the process creates customer preference information. Further aspects of step 240 are described in FIG. 10. After step 240, the process passes to step 280. In step 280, the process generates marketing information. In accordance with embodiments of the invention, there are various manners in which to generate the marketing information. FIGS. 4, 8, 9, 13, 15 and 17 show various processes in accordance with embodiments of the invention. Further aspects of these figures will be described below. After step 280 as shown in FIG. 2, the process passes to step 290. In step 290, the process ends the transaction based processing.

FIG. 3 is a flowchart showing in further detail the “obtain supplemental information” step 220 of FIG. 2. To explain, as shown in step 210 of FIG. 2, customer transaction information is obtained. However, this customer transaction information may be complimented by other data available from a variety of resources. For example, these resources might include demographic data, data from a credit bureau, or data from any of a variety of other sources. Further, the end-use of the data generated as a result of the processing described herein, should be considered in determining which type of data to utilize. That is, if the generated data will be widely distributed, then it may well be the situation that data from credit bureaus should not be utilized since confidentiality is mandated.

As shown in FIG. 3, the process passes from step 220 to step 222 in which the end use of the data is considered. Then, in step 224, the process inputs demographic data. Then, in step 225, the process inputs bureau data. Then, the process passes to step 226, in which the process inputs new data. After step 226, the process passes to step 228 in which the process returns to step 230 of FIG. 2.

FIG. 4 is a flowchart showing the step of generating marketing information 280 in accordance with one embodiment of the invention. Further embodiments of step 280 are described below. As shown in FIG. 4, the subprocess starts in step 280A and passes to step 310. In step 310, the suitable processor selects a portfolio. Then, in step 320, a first population is defined in the portfolio. For example, the first population may simply be an account list. Further details of step 320 are described in FIG. 5.

After step 320, the process passes to step 340. In step 340, the distinguishing preferences of the first population are determined. Then, in step 360, persons in a second population are identified using distinguishing preferences. That is, the second population constitutes a population in which it is desired to identify persons to target. Further details of step 360 are described below and shown in FIG. 6. After step 360, the process passes to step 380 of FIG. 4. As shown in step 380, the process then returns to step 290 of FIG. 2.

FIG. 5 is a flowchart showing in further detail the step for defining the first population in a portfolio 320 of FIG. 4. As shown in FIG. 5, various techniques may be utilized to define the first population in the portfolio. In accordance with one embodiment as shown in step 324, the first population may be defined based on name matching with an external account list. For example, the external account list might be obtained from a partner in business. Alternatively, as shown in step 325, the first population might be defined based on filtering the relevant accounts using behavior and/or risk criteria. In accordance with a yet further embodiment, as shown in step 326, the first population might be defined based on an account list. After the first population is defined using one of steps (324, 325, 326) the process passes to step 328. In step 328, the process returns to step 340 of FIG. 4.

FIG. 6 is a process showing in further detail the “identify persons in the second population, i.e., persons to target, using the distinguishing preferences” step 360 of FIG. 4. As shown in FIG. 6, the process starts in step 360 and passes to step 361. In step 361, a suitable processor implementing the invention retrieves the distinguishing preferences. Then, in step 362, the suitable processor rank orders the accounts in the second population based on the degree of matching with the distinguishing preferences. As a result, the second population is broken into subsets, e.g., subset A, subset B, subset C, and so forth.

After step 362, the process passes to step 363. In step 363, the suitable processor identifies persons in the second population based on rank ordered accounts. Further details of step 363 are described below with reference to FIG. 7. After step 363, the process passes to step 369 in which the process returns to step 380 of FIG. 4.

FIG. 7 is a flowchart showing in further detail the “identify persons in the second population based on rank ordered accounts” step 363 of FIG. 6. As shown in FIG. 7, the process passes from step 363 to step 364. In step 364, the suitable processor generates a first wave of marketing activity based on the top ranked subset of the second population. Illustratively, the wave of marketing activity might be a wave of mailings out to identified persons. After step 364, the process passes to step 365. In step 365, the process determines the effectiveness of the current wave of marketing activity based on the current subset. That is, for example, the first wave of marketing activity to the most likely consumers to respond might obtain a response rate of 60%. If the response in the first wave is favorable enough, then a second wave of marketing activity might be pursued. However, it might be the situation that the second wave of marketing activity does not attain the desired success. As a result, further waves of marketing activity might not be pursued.

Accordingly, after step 364 of FIG. 7, the process passes to step 365. In step 365, the effectiveness of the current wave of marketing activity based on the current subset; i.e., the first wave of marketing activity in this situation, is determined. Then, the process passes to step 366. In step 366, the process determines whether the effectiveness of the current wave of marketing activity is satisfactory to proceed with a subsequent level, i.e., further wave. For example, the satisfaction of predetermined thresholds might be utilized. If the effectiveness of the current wave of marketing activity is satisfactory, then the process passes from step 366 to step 367. In step 367, based on the next ranked subset of the second population, the process generates the next wave of marketing activity. For example, mailings. After step 367, the process returns to step 365. As described above, in step 365, the effectiveness of this next ranked subset of marketing activity is then determined. Then the process proceeds to step 366.

Alternatively, if the effectiveness of the current wave of marketing activity is not satisfactory to proceed with the subsequent level, then the process passes from step 366 to step 368. In step 368, the process returns to step 369 of FIG. 6.

FIG. 8 is a flowchart showing the step of generating marketing information in accordance with a further embodiment. As shown in FIG. 8, the process starts in step 280B and passes to step 410. In step 410, the process identifies consumer channel preferences. These consumer channel preferences might include direct mail, outbound telemarketing, Internet catalogue and/or television, for example. After step 410, the process passes to step 420. In step 420, the identified consumer preference channels are ranked. Then, in step 440, a two-score grid is generated to rate each customer by channel preference and product preference. Then, in step 460, the process identifies customers, i.e., consumers, to target based on each customers' respective disposition within the grid. Then, in step 480, the process returns to step 290 of FIG. 2.

FIG. 9 is a flowchart showing the generate marketing information step 280 of FIG. 2 in accordance with a further embodiment of the invention. As shown in FIG. 9, the process starts in step 280C and passes to step 510. In step 510, the process determines merchant zip codes associated with purchases by a particular customer. In particular, such purchases are transacted over a period of time. Then, in step 520, the process tracks a change in merchant zip codes, i.e., those purchases associated with a particular customer, over time. Then, in step 540, the process determines the distance between zip codes and the rate of change of merchant zip codes over time.

As a result, the process determines the rate of moving of the particular consumer. Accordingly, if a person effects a transaction in New York City at 4:00 and effects a subsequent transaction at 5:00 in Los Angeles, such data is suggestive of fraudulent activity. However, such tracking of zip codes may be utilized to identify various other behavior. After step 540, the process passes to step 560. In step 560, the process determines fraud risk, vacation and/or business travel, for example, based on shifts in merchant zip codes over time. After step 560, the process passes to step 580. In step 580, the process returns to step 290 of FIG. 2.

In accordance with one embodiment of the invention, FIG. 10 is a flowchart showing the “create customer preference information” step 240 of FIG. 2 in further detail. As shown in FIG. 10, the process starts in step 240 and passes to step 242. In step 242, the process identifies a particular class of merchant to consider. Then, in step 250, the process identifies transaction data that is associated with the particular class and/or merchant. Further details of step 250 are described below with reference to FIG. 11.

After step 250, the process passes to step 260. In step 260, the process tracks state variables associated with the identified transaction data. Various state variables may be tracked. Illustratively, in step 272, a volume of the identified transaction data is tracked. As shown in step 274, the recency of the identified transaction data is tracked. Alternatively or in addition to, in step 276, the frequency of the identified transaction data is tracked.

After any of steps (272, 274, 276) the process passes to step 277. In step 277, the process identifies the likely events in the population associated with identified transaction data based on state variables; i.e., these events may be indicative of or relate to fraud risk, vacation and/or business travel, for example. After step 277, the process passes to step 278. In step 278, the process returns to step 280 of FIG. 2.

FIG. 11 is a flowchart showing in further detail the identify transaction data that is associated with a particular class and/or merchant step 250 of FIG. 10. After step 250, the process passes to step 252. In step 252, the process identifies the particular class of merchandise that is of interest, in accordance with this embodiment of the invention. Then, in step 254, the process identifies all the merchants that are associated with the particular class of merchandise. That is, in step 254, it may be the situation that a particular name of a particular merchant is known to be associated with the merchandise of interest. However, other names of that same merchant are not known to be associated with the particular merchandise of interest.

Accordingly, it is necessary to associate different names for the same merchant. FIG. 12 is a flowchart showing further aspects of step 254. That is, in step 255, the process generates a plurality of merchant indicia that are associated with a given merchant. Then in step 256, the process maps each of the plurality of merchant indicia to the single merchant. As a result, data associated with each particular merchant is not compromised by the fact that the merchant may be identified by different names among various databases, for example. After step 256 of FIG. 11, the subprocess returns to FIG. 11 and step 257.

That is, after step 254 of FIG. 11, the process passes to step 257. In step 257, the process aggregates all the transactions associated with the identified merchant to generate identified transaction data. After step 257, the process passes to step 258. In step 258, the process returns to step 260 of FIG. 10.

FIG. 13 is a flowchart showing in further detail the “generate marketing information” step 280 of FIG. 2, in accordance with one embodiment of the invention. As shown in FIG. 13, the process starts in step 280D and passes to step 610. In step 610, the process identifies a demographic variable present in population preference data. For example, the demographic data might be zip codes. After step 610, the process passes to step 620. In step 620, the process established ranges of the demographic variable, e.g., ranges of zip codes. Then, in step 630, the process groups the population preference data based on the established ranges. In other words, the process segments the population as desired. After step 630, the process passes to step 640 and returns to step 290 of FIG. 2.

FIG. 14 is a flowchart showing in further detail the organize the input customer purchase information step 230 of FIG. 2. As shown in FIG. 14, the process starts in step 230 and passes to step 232. In step 232, the process determines the classifications of merchants. Step 232′ illustrates a further aspect of this classification. It may be the situation that the classification of a particular merchant may be determined based on various available data that is obtainable with regard to that merchant. However, later in time, it may be the situation that the entity maintaining the suitable processor may come into partnership with that particular merchant. As a result, the classification of the particular merchant might be cross-checked against actual data and further information obtained from a particular merchant; i.e., data that is available as a result of a recent partnership. As a result, step 232′ illustrates that the classification may be later confirmed when working in partnership with a particular merchant.

As shown in FIG. 14, after step 232, the process passes to step 234. In step 234, for each merchant in the customer transaction information, the process determines the classification in which a particular merchant falls. That is, the process maps a merchant record to a classification; or associates a merchant's record to a further merchant record that is already mapped (234′). After step 234 of FIG. 14, the process passes to step 236. In step 236, the process organizes the input customer purchase information based on the classified merchants. Then, the process passes to step 238, in which the process returns to step 240 of FIG. 2.

FIG. 15 is a flowchart showing the “generate marketing information” step 280 of FIG. 2 in accordance with a yet further embodiment of the invention. As shown in FIG. 15, the process starts in step 280E and passes to step 700. In step 700, the process targets a first account type (held by a customer) that is maintained by the subject entity (e.g. BANK ONE). The first account type is defined by attributes of that account. Then, in step 710, the process analyzes the first account type to determine the use of a second account type held by the customer (the second account being maintained by a different entity). The processing of step 710 utilizes a model in accordance with one embodiment of the invention. Further details of the processing of step 710 are described below with reference to FIG. 16.

In other words, as described below with reference to FIG. 16, the process leverages customer data of customers who have all spending recorded in the database (have all accounts with the subject entity) against customers having only a fraction of accounts with the subject entity. The processing might be characterized as imputing the missing preferences from the customer that only has a portion of his or her accounts with the subject bank.

After step 710 of FIG. 15, the process passes to step 720. In step 720, the process generates features of the second account type based on the use (of the second account type) that is determined. In other words, the subject bank determines the likely characteristics of the accounts of the customer that are not maintained by the subject bank. In an effort to secure a greater extent of the customer's business, the subject bank then, in step 730, offers an account to the customer that satisfies the features of the second account type of the customer, which is not currently maintained by the subject entity, e.g., a bank.

After step 730, the process passes to step 740. In step 740, the process returns to step 290 of FIG. 2.

FIG. 16 is a flowchart showing the “analyze the first account type to determine the use of a second account type held by the customer (the second account type being maintained by a different entity)” step 710 of FIG. 15 in further detail. As shown in FIG. 16, the subprocess starts in step 710 and passes to step 711.

In step 711, the process generates a pool of customers who have essentially all their accounts, or at least all the accounts of interest, with the subject entity, e.g., BANK ONE. Accordingly, the aggregation is performed at a customer level. However, it is further noted that aggregation may be alternatively based on households, for example, rather than at a customer level. After step 711, the process passes to step 712.

In step 712, the process determines accounts of interest that have attributes similar to the first account type, i.e., the process identifies what might be characterized as “corresponding first accounts.” Then, in step 713, the process, for each of the corresponding first accounts, identifies attributes associated with other accounts held by the same customer, i.e., “potentially corresponding second accounts” (e.g., balance and volume on the other accounts). Then, in step 714, the process compares attributes of the potentially corresponding second accounts with attributes of the “second account type” of the customer in order to identify potentially corresponding second accounts that match with the second account type. The attributes of the second account type may be available through various sources, e.g., bureau data.

After step 714, the process passes to step 715. In step 715, the process tags “potentially corresponding second accounts that match with the second account type” as “corresponding second accounts.” It should be appreciated that the degree of matching between such accounts may be varied as desired, i.e., thresholds to use in the matching processing may be controlled as desired.

The subject bank then analyses the use of the identified corresponding second accounts. That is, in step 716, the process infers the use of the second account type based on the use of the “corresponding second accounts.” After step 716, the process passes to step 717. In step 717, the process returns to step 720 of FIG. 15.

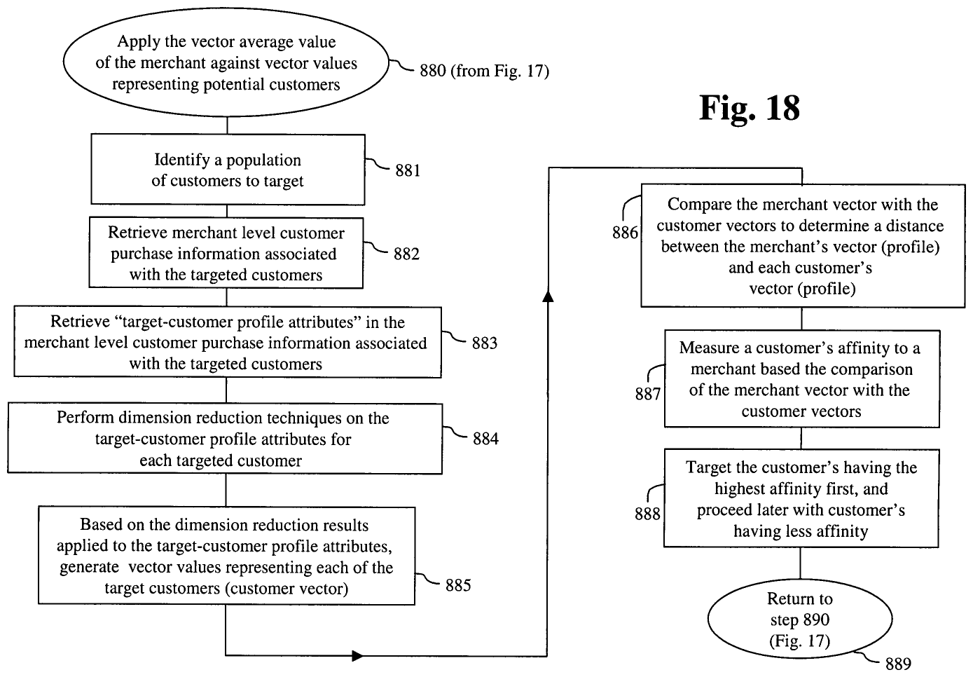

In accordance with a further aspects of the invention, FIG. 17 is a flowchart showing another embodiment of the “generate marketing information” of FIG. 2. In particular, the process of FIG. 17 relates to customer and merchant profiling.

As shown in FIG. 17, the subprocess starts in step 280F and passes to step 800. In step 800, the process identifies a merchant of interest. The merchant might be a seller of goods or a provider of services, for example. After step 800, the process passes to step 810.

In step 810, the process retrieves customer transaction information associated with the merchant of interest. That is, if the merchant of interest is Company_A, the process retrieves information relating to transactions with Company_A. Then, in step 830, the process identifies attributes in the customer transaction information for use in the profiling. These attributes might be characterized as “profile attributes.” After step 830, the process passes to step 840.

In step 840, the process performs dimension reduction techniques on the profile attributes to generate a customer profile for each merchant customer, i.e., using transactions associated with that customer. That is, for example, such dimension reduction techniques might include applying principle component analysis and/or applying mixture of multinomial models. Then in step 850, based on the dimension reduction results applied to the attributes, the process generates an N-dimensional vector representing each of the merchant customers.

In other words and to explain, the process in accordance with one embodiment of the invention identifies particular attributes that are associated with customers of a particular merchant. Based on these identified attributes, a vector is generated for each such customers. The process then combines these vectors.

That is, in step 860, based on the vector values representing each of the merchant customers, the process generates a vector-average value collectively representing all the identified customers of the merchant. In other words, this vector may be thought of as representing the merchant, i.e., and constituting a “merchant vector.”

After step 860, the process passes to step 880. In step 880, the process applies the vector average value of the merchant against vector values representing potential customers. Further details of the processing of step 880 are described below with reference to FIG. 18.

After step 880 of FIG. 17, the process passes to step 890. In step 890, the process returns to step 290 of FIG. 2.

In accordance with one embodiment of the invention, FIG. 18 is a flowchart showing in further detail the “apply the vector average value of the merchant against vector values representing potential customers” step 880 of FIG. 17. As shown FIG. 18, the process starts in step 880 and passes to step 881. In step 881, the process identifies a population of customers to target using the merchant vector. That is, the objective of the processing of FIG. 18 is to identify persons in a target population that have an affinity for the particular merchant of interest.

After step 881 of FIG. 18, the process passes to step 882. In step 882, the process retrieves customer transaction information associated with the targeted customers, i.e., persons in the target population. Then, in step 883, the process retrieves “target-customer profile attributes” from the transaction information associated with the targeted customers. That is, the process obtains attributes to be used in the generation of a vector for each person in the target population. Accordingly, in step 884, the process performs dimension reduction techniques on the target-customer profile attributes for each targeted customer. After step 884, the process passes to step 885.

In step 885, based on the dimension reduction results applied to the target-customer profile attributes, the process generates vector values representing each of the target customers. These vector values might be characterized as a “customer vector.” Then, in step 886, the process compares the merchant vector with the customer vectors to determine what might be characterized as a distance between the merchant's vector, i.e., the particular merchant's profile and each potential customer's vector, i.e., each potential customer's profile. After step 886, the process passes to step 887.

In step 887, the process measure a customer's affinity to a merchant based the comparison of the merchant vector with the customer vectors, i.e., the distance between the respective vectors. Another distance metric that could be used is the dot product of the merchant and customer vectors, i.e., the product of the two magnitudes of each vector, multiplied by the cosine of the angle between the two vectors. This processing provides the respective affinity of each person in the target population to the particular merchant.

FIG. 19 is a diagram showing aspects of the vector analysis of FIG. 18. In particular, FIG. 19 shows a two-dimensional space 852. The two-dimensional space 852 includes a dimension 1 854 and a dimension 2 853. The respective dimensions may be preferences, for example, as desired. However, it is appreciated that the systems and methods of the invention are of course not limited to two-dimensions. The vector analysis of FIG. 18 and FIG. 19 may be applied in additional dimensions. However, computer processing requirements will of course increase as additional dimensions are considered in an analysis.

As shown in FIG. 19, a vector 856 represents the merchant, i.e., “The Store.” Further, a vector 855 illustratively represents cardholders with children, and a vector 858 represents all AARP accounts. Further, the vector 857 represents a particular individual account. Accordingly, as shown in FIG. 19, it can be seen that there does seem to be an affinity between the vectors 855 and 856, i.e., between “The Store” and cardholders with children. However, there appears to be substantially less affinity between the vector 856 the vectors (857, 858), i.e., between “The Store” and the AARP cardholders, as well as “The Store” and the particular account represented by the vector 857. Accordingly, this information as depicted in FIG. 19 might be used for marketing purposes, such as targeting persons with children, in add campaigns.

Returning now to FIG. 18, after step 887, the process passes to step 888. In step 888, the process targets the customer's having the highest affinity first, and proceeds later with customer's having less affinity, in accordance with one embodiment of the invention. However, it is appreciated that once the affinity of each person in the target population is determined, i.e., using the processing of FIG. 18, that information may be used in any of a wide variety of manners, as desired.

After step 888, the process passes to step 889. In step 889, the process returns to step 890 of FIG. 17. Further processing may then be performed as described above.

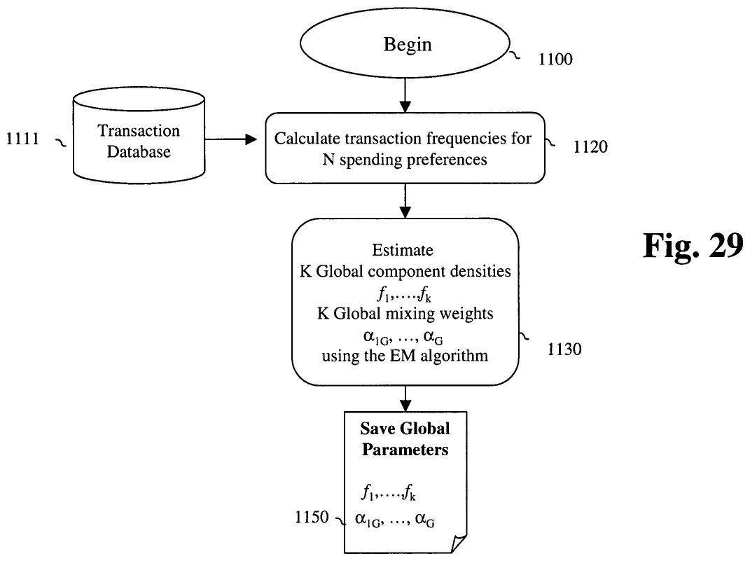

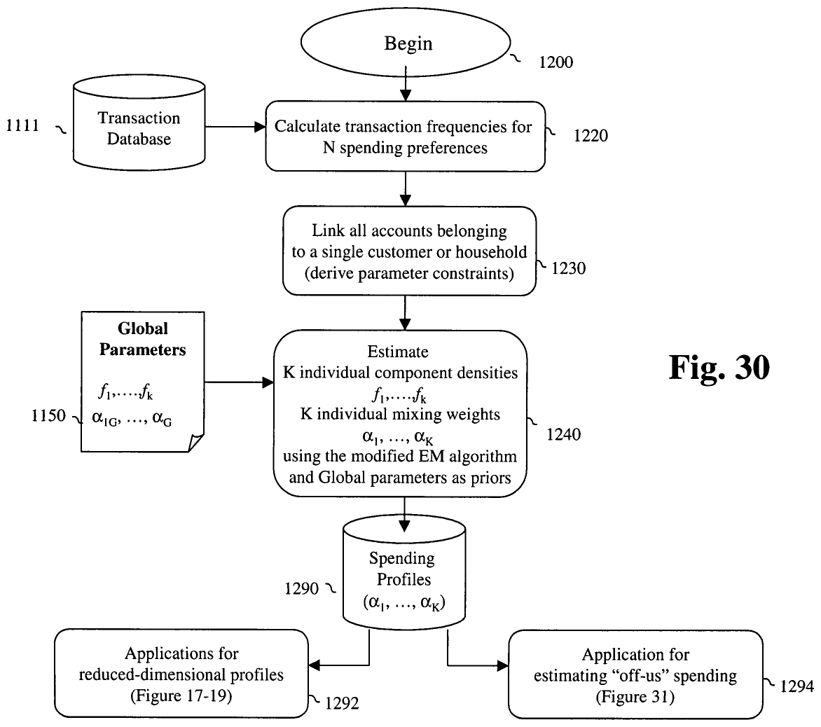

In accordance with further embodiments of the invention, aspects of utilizing multinomial models will hereinafter be described. Multinomial models are discussed above. FIGS. 29-31 are figures showing aspects of processing using multinomial models.

In particular FIGS. 29, 30, and 31 are flowcharts showing the “generate marketing information” step 280 of FIG. 2 in accordance with two further embodiments of the invention.

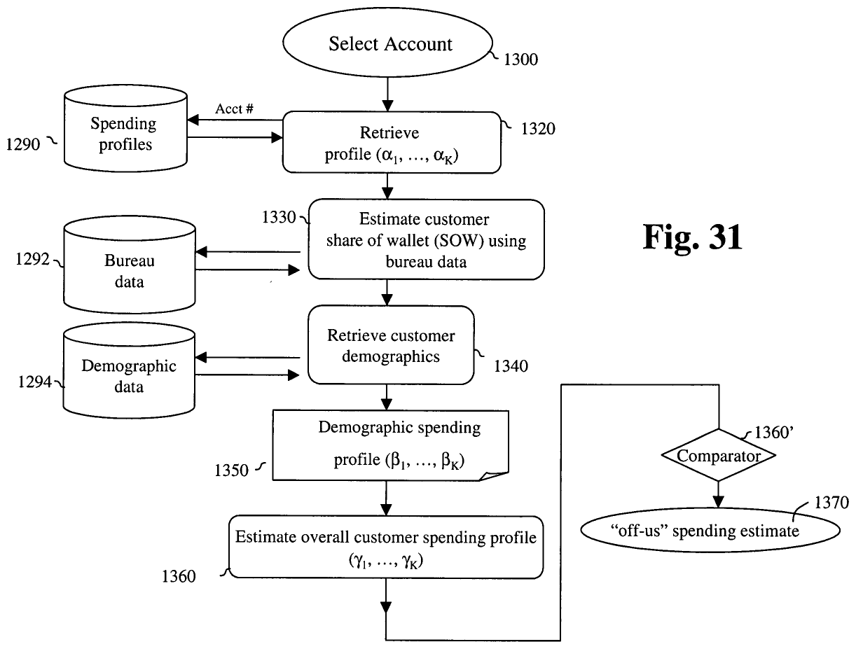

In particular, FIGS. 29 and 30 are flowcharts showing process steps involved in creating a low-dimensional spending profile, using mixtures of multinomial models. These profiles are one embodiment of dimension-reduction methods to be used in targeted marketing applications, i.e., such as discussed above in step 840 of FIG. 17. In addition, FIG. 31 shows the application of mixture models in predicting spending on a second account from the observed behavior of a first account, as discussed above with reference to FIG. 16.

In accordance with one embodiment of the invention, FIG. 29 shows a process involved in creating global component density functions and mixing weights. The process begins in step 1100 and passes to step 1120. In step 1120, transaction data from a transaction database 1111 is summarized by calculating the transaction frequency in each of N preferences. The resulting matrix has a record for each account in the database, with N fields.

Then, in step 1130, these data are used to estimate K component density functions (ƒ₁, . . . , ƒ_{K}) and the corresponding mixing weights (α_{1G}, . . . , α_{KG}) using an expectation maximization (EM) algorithm as discussed above. These global parameters are saved in step 1150, to be used as prior probability estimates for the individual-specific mixture model parameters, i.e., as described below with reference to FIG. 30.

FIG. 30 is a flowchart detailing the process used to generate a low-dimensional spending profile at the account, customer, or household-level, as depicted in the spending profile database 1290 of FIG. 30. As shown in FIG. 30, the process starts in step 1200 and passes to step 1220. In step 1220, data from the transaction database 1111 is retrieved and the process calculates transaction frequencies for each of N spending preferences. For individuals or households with more than one account, these spending preferences are then linked in step 1230 to establish constraints on the individual mixing weights, i.e., such that each individual has only one set of mixing weights.

Next, the process passes to step 1240. In step 1240, the individual-specific component densities and mixing weights are estimated using the modified EM algorithm and the global parameters (1150) to create prior probability estimates, as described above. The resulting individual-specific mixing weights constitute a “model” or “profile” 1290 of each individual's spending behavior. In other words, each individual is characterized by a vector of numbers (mixture weights α₁, . . . , α_{K}) indicating his degree of membership to each of the component density functions. Accordingly, it is appreciated that mixing weights may be used to profile a customer, or alternatively, principle component analysis may be used to profile a customer, or further, mixing weights and principle component analysis may be used together to profile a customer.

After step 1240 and the generation of the spending profiles 1290, the process of FIG. 30 passes to either of step 1292 and/or step 1294. In step 1292, the spending profiles are used in applications utilizing reduced-dimensional profiles. Alternatively, the process may pass to step 1294. In step 1294, the spending profiles are used in an application for estimating “off-us” spending,” i.e., such as in FIG. 31.

Accordingly, FIG. 31 is a flowchart showing how the individual-specific spending profiles 1290 can be used to make inferences of spending behavior on other account(s), in accordance with one embodiment of the invention. When the other accounts are with a different entity, this behavior may be characterized as “off-us” spending, in contrast to “on-us.” spending

As shown in FIG. 31, the process starts in step 1300 in which a particular account or accounts is selected. Then, in step 1320, the process identifies all of the known “on-us” spending, i.e., the spending on accounts of the particular customer that are with a first entity, i.e., the bank performing the analysis, for example. That is, in step 1320, the “on-us” spending profiles, i.e., the mixing weights, from all accounts for a given customer are pulled from the spending profile database 1290, created in the process described above and shown in FIG. 30.

Then, in step 1330, the sum of “on us” spending, divided by an estimate of an individual's total spending, which may be derived from bureau data records 1292 or other aggregated data sources for example, is used to estimate the total “Share of Wallet” (SOW), or percent of total customer spending “on-us”.

After 1330, the process passes to step 1340. In step 1340, the process extracts customer demographics from demographic data 1294. Then, in step 1350, the process creates a prior estimate of customer spending based on the customer's demographic profile. In step 1360, these two estimates (the spending profile derived from demographics and the spending profile derived from “on-us” spending) are combined with the share of wallet (SOW) estimate to create an estimate of the customer's overall customer spending. This estimate is compared to the “on-us” estimate, to infer the spending behavior on all accounts with second entities in step 1360. As a result, in step 1370, this comparison yields an “off-us” spending profile.

Accordingly, FIG. 31 shows a further process that leverages customer data of customers who have all spending recorded in the database, i.e., who have all accounts with the subject entity, against customers having only a fraction of accounts with the subject entity. The processing might be characterized as imputing the missing preferences from the customer that only has a portion of his or her accounts with the subject bank.

In accordance with further aspects of the invention, methods for deriving product demographics from transaction data will hereinafter be described. Prospect marketing begins with a list of prospects. These lists typically include the prospect's name, address, phone number, and a few known attributes. For example, the list source might be a subscriber list to a particular magazine. Marketers typically append additional attributes or variables to this list, such as credit bureau information. Still, the amount of information available on individual prospects is inherently limited. Hence, most marketing organizations use demographic data to create a “profile” of their customer base, to identify target populations, select marketing channels, craft marketing messages, and so on.

Demographic databases are known. Most known demographic databases are compiled from various sources, including surveys and polls, self-reported attributes and interests (e.g. questionnaires on warranty registrations), public records (home sales and vehicle registrations), census bureau data, etc. However, the systems and methods of the invention provide demographic data sources that are built off of actual purchase behavior. Furthermore, known demographic databases suffer from a variety of inaccuracies and biases. Warranty registrations and surveys suffer from sample bias, aspirational bias, and other inaccuracies. Samples are biased with respect of people willing to fill out surveys. Aspirational bias is perhaps more problematic. People often report hobbies, activities and spending behaviors that reflect their interests or self-image, rather than their actual behavior, i.e., “aspirational bias” means that people report characteristics about themselves that reflect their aspirations, rather than objective truth. Accordingly, there is often a large discrepancy between the people who might self-report an interest in golf (or regular exercise) and people who actually spend money on golf. Further, self-reported financial estimates are notoriously unreliable, for no other reason than most people do not really know how much money they spend on broad categories of products over a given year. For example, few people would know their annual spending on gasoline with any precision. Finally, many records in demographic databases are not regularly updated, hence information on a particular customer, population, or region is often obsolete.

In accordance with one embodiment of the invention, the systems and methods of the invention can be used to generate a demographic database directly from customer purchase information. Although data drawn from a single account may not give a full picture of an individual or household, data aggregated over millions of accounts yields a much more accurate picture of actual consumer spending behavior than traditional demographic data sources. First, transaction data is available on a much larger sample of the population than surveys or census. For example, in 2002 BANK ONE was tracking consumer behavior on a portfolio of over 40 million accounts. The transaction volume from these accounts represents a significant fraction (3-5%) of all credit and debit card transactions in the United States. Therefore, to the extent that the bank's portfolio is representative of the general consumer population, the spending activity at any given merchant is representative of their customer base. Second, transaction data is continuously being generated. As a result demographics derived from transaction data could be updated monthly or even daily.

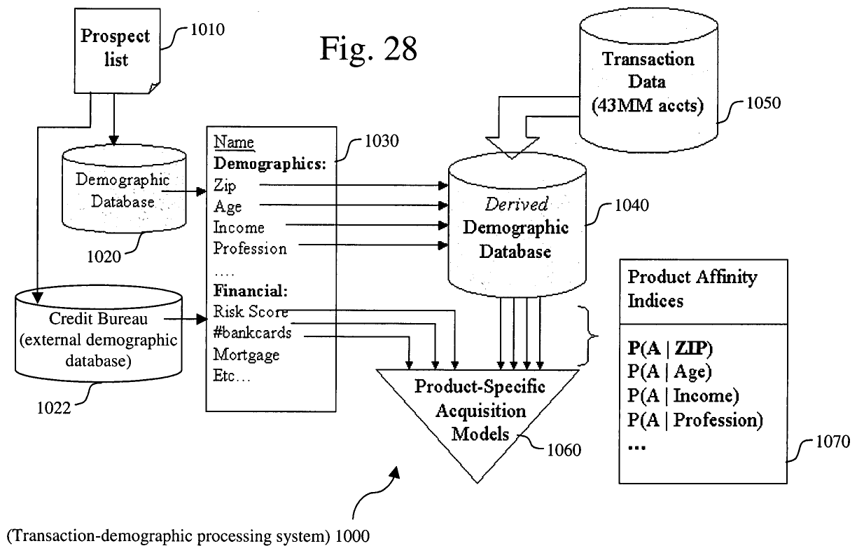

FIG. 28 is a block diagram showing aspects of a transaction-demographic processing system 1000, in accordance with one embodiment of the invention. The transaction-demographic processing system 1000 provides for the processing of demographic data in combination with transaction data.

To explain, the processing of FIG. 28 begins with a prospect list 1010. The prospect list 1010 is then input into a demographic database 1020 in order to obtain demographic information regarding each person, account or household, for example, on the prospect list. As a result, demographic information 1030 is obtained regarding each person on the prospect list. This demographic information may include (for each person, account or household, for example) zip, age, income, and/or profession. Further, based on the prospect list, as shown in FIG. 28, an external demographic database, such as an external credit bureau 1022, may be accessed to provide various financial information regarding persons, accounts or households, for example, on the prospect list. The financial information might include risk score, the number of bankcards, mortgage information, as well as any other suitable information.

As shown in FIG. 28, the demographic information is then used in conjunction with transaction data 1050. That is, the demographic information and the transaction data are used in combination to generate a derived demographic database 1040. The data in the derived demographic database 1040 may vary in nature depending on the particular information desired. However, in general the data in the derived demographic database 1040 relates to the compilation of the demographic information with the transaction data in some predetermined manner.

As shown in FIG. 28, the derived demographic data is then output to product-specific acquisition models 1060, in accordance with one embodiment of the invention. Further, financial information may also be input into the product-specific acquisition models. The processing of FIG. 28 may also utilize product affinity indices 1070, i.e., such as zip, age, income and profession. The product affinity indices are used to further manipulate the data based on the particular objective desired. The product-specific acquisition models 1060 may in turn be used to provide a wide variety of information based on the available demographic information and the transaction data, as described herein.

In one aspect of the systems and methods of the invention, transaction data from existing customers can be used to impute product preferences of the population at large. For example, a preference for a particular merchant could be aggregated by customer's home address to find the relative density of that merchant's customers by ZIP code. These data could then be used to target direct mail campaigns to neighborhoods that are most likely to purchase the product. More generally, any number of preferences could be aggregated along key demographic factors, to derive population-level demographics, i.e., such as age, income, location, product preferences, etc., for any retail merchant, product, or service. Some example applications are given below for illustrative purposes.

An example is targeting airline promotions, as described below.

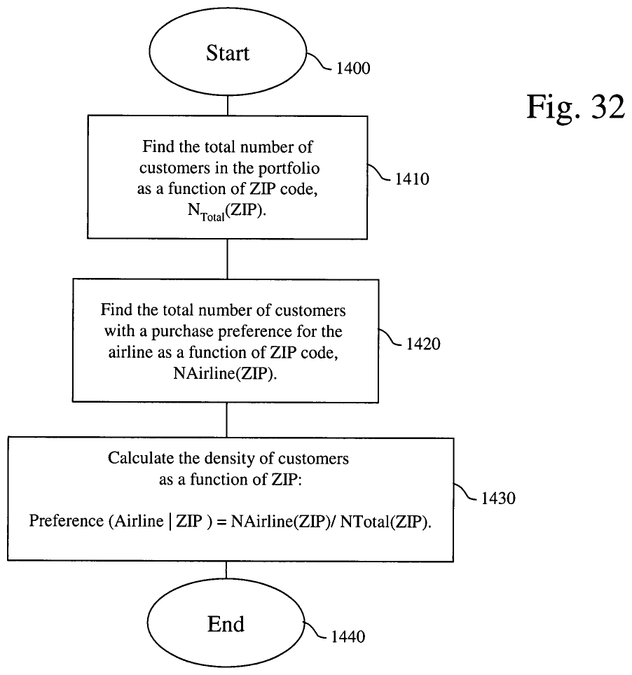

Assume an airline (“Airline X”) is interested in conducting a direct mail promotion to prospective customers near its hub cities. A crude solution would be to mail the offer to all ZIP codes within a 50-mile radius of the corresponding hub airports. However, there will clearly be valuable customers overlooked by this strategy because they live outside these boundaries and probably neighborhoods within these boundaries that have such a low rate of air travel that the offer would be uneconomic. If the airline maintained a list of ZIP codes of their existing customers, they could target their mail to those ZIP codes with the highest percentage of customers. Alternatively, transaction data, could be used to define the target ZIP codes. FIG. 32 is illustrative of such a process in accordance with one embodiment of the invention.

As shown in FIG. 32, the process starts in step 1400 and passes to step 1410. In step 1410, the process operates on a particular portfolio of customers and uses zip code information in that portfolio. In particular, the process of FIG. 32 finds the total number of customers in the portfolio as a function of ZIP code, N_{Total}(ZIP). Then, the process passes to step 1420.

In step 1420, the process finds the total number of customers with a purchase preference for the airline as a function of ZIP, N_{Airline}(ZIP). After step 1420, the process passes to step 1430.

In step 1430, the process calculates the density of customers as a function of ZIP using the results of steps 1410 and 1420. For example, step 1430 may use the relationship:

Preference(Airline|ZIP)=N_{Airline}(ZIP)/Nₜₒₜₐₗ(ZIP).

This processing results in a table that shows the preference for the particular airline by zip code. This preference information might be graphically shown on a map, for example.

The resolution or specificity of this table depends on the absolute number of counts in each category. With 43 million customers, over 95% of 5 digit ZIP codes will have statistically significant counts. In some cases, estimates may be possible at the 9-digit ZIP code or census block level. Estimates for cells with small counts can be improved using statistical smoothing techniques. (see Ristad, E. S. A natural law of succession. Research Report CS-TR-495-95 (1995) Johns Hopkins University).

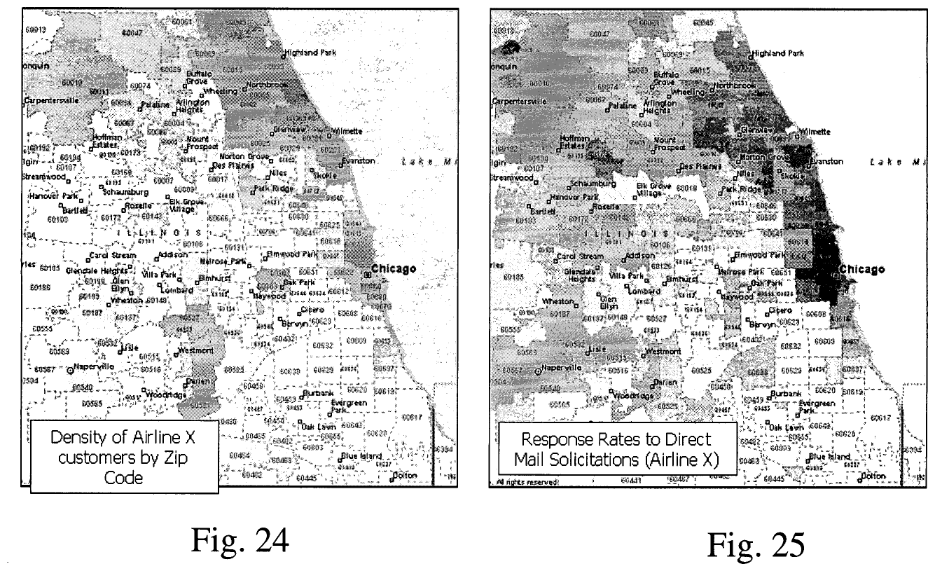

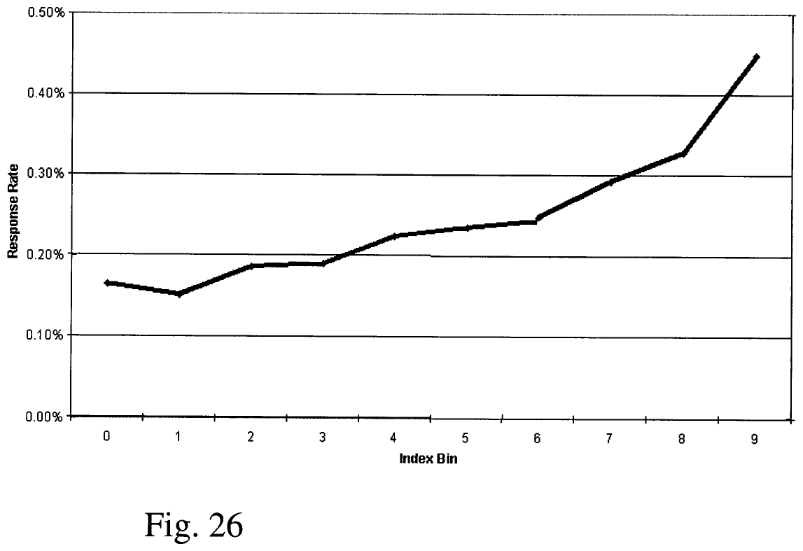

In accordance with one embodiment of the invention, FIG. 24 shows the density of customers for a major domestic airline, as calculated by the method just described. FIG. 25 shows the corresponding response rates from a random, direct mail campaign to this region. FIG. 26 shows the degree of correlation between the density of customers and density of direct mail responders. Notice that residents in ZIP codes with a density rating in the top 10% are 50% more likely to respond to mail offers than average.

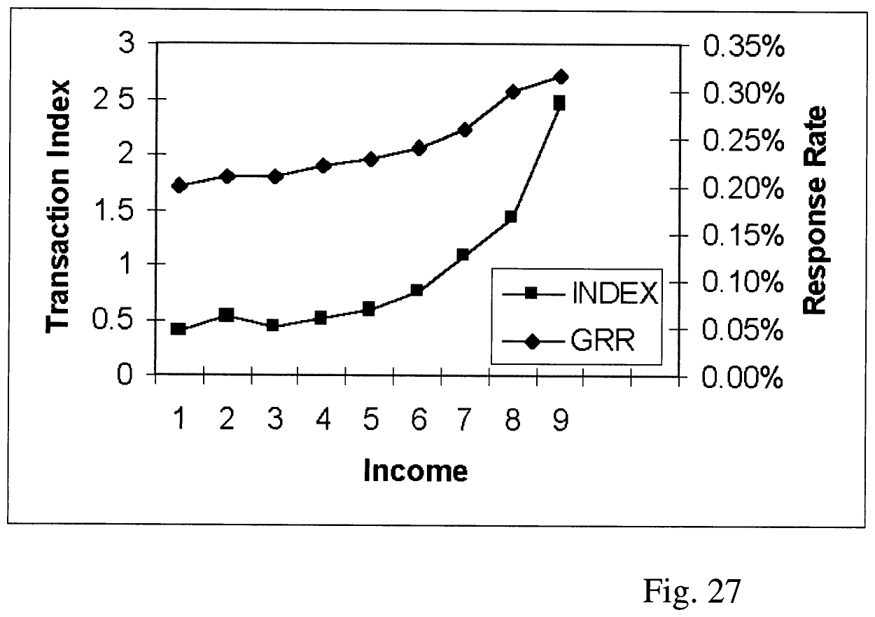

Product (or merchant) preferences can be aggregated along any number of demographic variables, including cardholder age, gender, marital status, income, home ownership, family size, and so on. For example, FIG. 27 shows the density of customers with purchases at Airline “X” as a function of income. Again, there is a clear correlation between response rate and the index value, indicating the income index would be a good predictive variable. This further suggests that a model combining ZIP code and income would likely yield even more accurate predictions of response for targeted marketing.

In accordance with further embodiments of the invention, demographic attributes may be combined so as to create customer profiles. To explain, assume a merchant possesses a list of prospects with four known attributes (age, income, ZIP code, and occupation). Transaction data could be aggregated to create four demographic preference indices:

Prob (Purchase at Airline X|ZIP)

Prob (Purchase at Airline X|age)

Prob (Purchase at Airline X|income)

Prob (Purchase at Airline X|occupation)

There are several ways to combine evidence to create a demographic profile, including creating a set of logical rules to select the target population. However, in general the best way to fully exploit these data is to create a statistical model that estimates the function:

Prob (Response|ZIP, Age, income, & occupation).

In accordance with one embodiment of the invention, a response model is used. That is, if historical response data from previous campaigns is available, the most direct way to combine evidence derived from a preference engine (or any other demographic data source) is to build a response model. Inputs to the model could be the preference index corresponding to each demographic variable, which is schematically illustrated in FIG. 28. The model prediction, then, would be precisely a prediction of an individual's response to an offer, given the known information.

In accordance with a further embodiment of the invention, an affinity model may be utilized. That is, for a new product or campaign, one does not have the benefit of historical data. However, data in a preference engine can still be used to generate a profile, by creating a “proxy” for response. One logical candidate prediction is to predict whether or not a customer is likely to make a purchase from Airline X, regardless of any marketing activities:

Prob (Purchase at Airline X|ZIP, Age, income, & occupation).

We refer to this as an “Affinity model”, since it predicts whether or not a customer has an affinity to a particular product or merchant, rather than whether they would respond to the particular channel or terms in a solicitation. This is a direct extension of the method illustrated for targeting a customer based on a single variable, i.e., such as ZIP code.

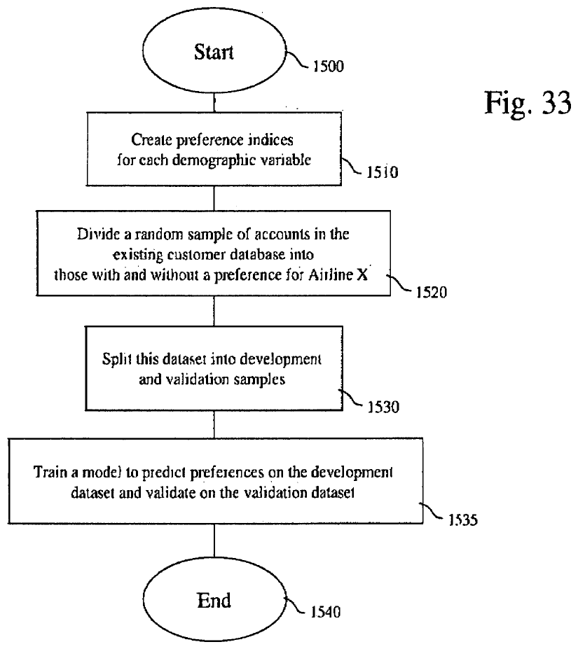

In accordance with one embodiment of the invention, the steps required to build an affinity model is shown in FIG. 33. As shown in FIG. 33, the process starts in step 1500 and passes to step 1510. in step 1510, the process creates preference indices for each demographic variable, as desired.

Then, in step 1530, the process divides a random sample of accounts in the existing customer database into those with and without a preference for Airline X. In step 1530, this dataset is then split into development and validation samples. This splitting allows training and validation of the models. That is, in step 1530, the process trains the model to predict preferences on the development dataset and validates on the validation dataset using only variables that are available for prospects. That is, a model in accordance with this aspect of the invention is developed using data from the existing customers of an entity to determine information about new customers of the entity. Accordingly, as can be appreciated, a wide variety of information is available for the existing customers that is not available for new customers. However, only that information (of existing customers) that will be available for new customers is used in the development of the models.

With regard to calibration, it is noted that, of course, depending on the quality of the solicitation offer and any number of factors, the affinity model's prediction may turn out to be only weakly correlated with response. However, the contribution of the affinity model to a response prediction can be modified (calibrated) after a test campaign is launched. When used in combination with a general solicitation model (a model that predicts responsiveness to the particular solicitation channel), the affinity model score can be used in combination as illustrated in FIG. 28.

Hereinafter, general aspects of possible implementation of the inventive technology will be described. Various embodiments of the inventive technology are described above. In particular, various steps of embodiments of the processes of the inventive technology are set forth. Further, various illustrative operating systems are set forth. It is appreciated that the systems of the invention or portions of the systems of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, various sets of instructions may be used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A method, implemented in a computer system, for determining customer affinity to a merchant, the computer system comprising a preference engine and a tangibly embodied processor for processing the customer transaction data, the method comprising:
storing, in a database, the customer transaction data from the plurality of sources, the database coupled to the preference engine;
receiving, via an electronic input, the customer transaction data, the customer transaction data relating to spending characteristics of transactions at a plurality of merchant entities;
appending, by the preference engine, customer demographic information to the customer transaction data, the customer demographic information including customer demographic variables;
classifying, by the preference engine, the customer transaction data within a predetermined organizational structure, includes organizing the customer transaction data based at least in part on a classification associated with the plurality of merchant entities;
aggregating, by the preference engine, the customer transaction data based on at least one of the customer demographic variables, the classification of the plurality of merchant entities, and the spending characteristics;
generating, by the preference engine, a customer profile based on the customer transaction data; and
wherein the method further includes:
identifying, by the preference engine, a specific merchant entity of the plurality of merchant entities and generating a merchant profile for that specific merchant entity; and
generating, by the preference engine, marketing information based on a degree of matching between the customer profile and a merchant profile of the specific merchant entity, wherein generating marketing information comprises:
determining, by the preference engine, merchant zip codes based on the customer transaction data for respective purchases of the customer at the plurality of merchant entities, and
determining, by the preference engine, over a period of time, a distance between the merchant zip codes in order to determine a rate of moving of the customer; and
wherein the degree of matching between the customer profile and a merchant profile of the specific merchant entity is indicative of an affinity of the customer to the specific merchant entity.

2. (canceled)

3. The method of claim 1, wherein the merchant entity is one of a product provider and a service provider.

4. The method of claim 1, wherein the predetermined organizational structure is a model.

5. The method of claim 1, wherein the customer profile relates to a single customer.

6. The method of claim 1, wherein the customer profile relates to a group of customers.

7. The method of claim 1, wherein the customer demographic variables includes at least one of zip code of the customer, income of the customer and profession of the customer.

8. (canceled)

9. The method of claim 1, wherein the creating the customer profile based on the customer transaction data further includes utilizing external credit data, the external credit data being publicly available.

10. The method of claim 9, wherein the external credit data is obtained from a credit bureau.

11. The method of claim 9, wherein the external credit data includes at least one of risk score information, number of bankcards of a customer and mortgage information relating to a customer.

12. The method of claim 1, wherein the customer transaction data includes at least one of customer purchase information obtained from customers and transaction records relating to customer purchases.

13. The method of claim 1, wherein the creating a customer profile based on the customer transaction data includes:
calculating the transaction frequencies for N spending preferences;
linking all accounts belonging to a single customer entity;
estimating K individual component densities; and
estimating K individual mixing weights.

14. The method of claim 13, wherein the estimating K individual component densities and estimating K individual mixing weights are performed by using an expectation maximization algorithm and global parameters as priors.

15. The method of claim 13, wherein a single customer entity is one of a single customer and a single household.

16. The method of claim 13, wherein the customer profile is applied in an off-us spending analysis.

17. The method of claim 1, wherein the customer profile relates to spending associated with a particular entity, and the method further includes:
generating a share of wallet estimate based on the customer profile and bureau data;
generating a prior estimate of customer spending based on the customer demographic information in the customer profile; and
combining the customer profile and the prior estimate of customer spending along with the share of wallet estimate to generate an estimate of the customer's overall customer spending profile.

18. The method of claim 17, further including comparing the estimate of the customer's overall customer spending profile with spending associated with the particular entity to determine the spending behavior on all accounts with other entities.

19. The method of claim 1, wherein the method further includes performing the steps, based on a plurality of generated customer profiles, of:
finding the total number of customers in a portfolio as a function of zip code NₜₒₜₐₗZIP);
finding the total number of customers with a purchase preference for a particular merchant entity as a function of zip code (NₐᵢᵣₗᵢₙₑZIP);
and calculating a density of customers as a function of zip code based on a ratio of N_{airline|}ZIP/NₜₒₜₐₗZIP.

20. A computer system that determines customer affinity to a merchant, the customer system comprising:
a database that stores the customer transaction data from the plurality of sources,
an electronic input, coupled to the database, that receives the customer transaction data, the customer transaction data relating to spending characteristics of transactions at a plurality of merchant entities;
the preference engine, coupled to the database and the electronic input, and comprising a processor programmed to perform the steps of:
appending customer demographic information to the customer transaction data, the customer demographic information including customer demographic variables;
organizing the customer transaction data within a predetermined organizational structure, includes organizing the customer transaction data based at least in part on a classification associated with the plurality of merchant entities;
aggregating the customer transaction data based on at least one of the customer demographic variables, the classification associated with the plurality of merchant entities, and the spending characteristics; and
creating a customer profile based on the customer transaction data.

21. A method, implemented in a computer system, for determining customer affinity to a merchant, the computer system comprising a preference engine and a tangibly embodied processor for processing the customer transaction data, the method comprising:
storing, in a database, the customer transaction data from the plurality of sources, the database coupled to the preference engine;
receiving, via an electronic input by a receiving module, the customer transaction data, the customer transaction data relating to a plurality of merchant entities;
appending, by the preference engine, customer demographic information to the customer transaction data, the customer demographic information including customer demographic variables;
determining, by the preference engine, a classification for each of the plurality of merchant entities, such determining including, for each merchant in the customer transaction data:
determining the classification in which a particular merchant falls by (1) mapping a merchant record to a classification, OR (2) associating a merchant record to a further merchant record that is already mapped;
classifying, by the preference engine, the customer transaction data based at least in part on the classification for each of the plurality of merchant entities;
aggregating, by the preference engine, the customer transaction data based on at least one of the customer demographic variables and the classification for each of the plurality of merchant entities;
generating, by the preference engine, a customer profile based on the customer transaction data and the processing module disposed on and executed by the tangibly embodied processor of the computer system.
